(19) United States
(12) Patent Application Publication
(10) Pub. No.: US 2019/0225232 A1
(43) Pub. Date: Jul. 25, 2019

(54) Passenger Experience and Biometric Monitoring in an Autonomous Vehicle

(71) Applicant: Uber Technologies, Inc., San Francisco, CA (US)

(72) Inventor: Joseph Blau, Pittsburgh, PA (US)

(21) Appl. No.: 15/895,381

(22) Filed: Feb. 13, 2018

Related U.S. Application Data
(60) Provisional application No. 62/620,735, filed on Jan. 23, 2018.

(51) Int. Cl. B60W 50/00; G05D 1/00; B60W 40/08

(52) U.S. Cl. CPC B60W 50/0098; G05D 1/0088; B60W 40/08; B60W 2050/0014; B60W 2510/30; B60W 2520/105; B60W 2520/06; B60W 2520/125; B60W 2550/142; B60W 2540/22

(57) ABSTRACT

Systems, methods, tangible non-transitory computer-readable media, and devices for operating an autonomous vehicle are provided. For example, vehicle data and passenger data can be received by a computing system. The vehicle data can be based on states of an autonomous vehicle and the passenger data can be based on states of one or more passengers of the autonomous vehicle. In response to the passenger data satisfying one or more passenger experience criteria, one or more unfavorable experiences by the one or more passengers can be determined to have occurred. The one or more passenger experience criteria can specify one or more unfavorable states associated with the one or more passengers. Passenger experience data can be generated based on the vehicle data and the passenger data at one or more time intervals associated with the one or more unfavorable experiences by the one or more passengers.

### RELATED APPLICATION

The present application is based on and claims benefit of U.S. Provisional Patent Application No. 62/620,735 having a filing date of Jan. 23, 2018, which is incorporated by reference herein.

### FIELD

The present disclosure relates generally to monitoring the state of an autonomous vehicle and a passenger of the autonomous vehicle including monitoring biometric states of the passenger of an autonomous vehicle.

### BACKGROUND

The operation of vehicles, including autonomous vehicles, can involve a variety of changes in the state of the vehicle based on a variety of factors including the environment in which the vehicle is traveling and performance characteristics of the vehicle. For example, vehicles with more powerful engines or lighter components can achieve different levels of performance from vehicles with less powerful engines or heavier components. Further, the vehicle can carry passengers that respond to the changes in the way the vehicle is operated. As the vehicle operates in various different environments under different conditions, the passengers can respond in different ways. Accordingly, there exists a need for a way to more effectively determine various states including vehicle states and the states of occupants inside the vehicle, thereby improving the experience of traveling inside the vehicle.

### SUMMARY

Aspects and advantages of embodiments of the present disclosure will be set forth in part in the following description, or may be learned from the description, or may be learned through practice of the embodiments.

An example aspect of the present disclosure is directed to a computer-implemented method of monitoring the state of an autonomous vehicle and a passenger of an autonomous vehicle. The computer-implemented method can include receiving, by a computing system including one or more computing devices, vehicle data and passenger data. The vehicle data can be based at least in part on one or more states of an autonomous vehicle and the passenger data can be based at least in part on one or more sensor outputs associated with one or more states of one or more passengers of the autonomous vehicle. Responsive to the passenger data satisfying one or more passenger experience criteria, the method can include determining, by the computing system, that one or more unfavorable experiences by the one or more passengers have occurred. The one or more passenger experience criteria can specify one or more unfavorable states associated with the one or more passengers. Further, the method can include generating, by the computing system, passenger experience data based at least in part on the vehicle data and the passenger data at one or more time intervals associated with the one or more unfavorable experiences by the one or more passengers.

Another example aspect of the present disclosure is directed to a computing system, that includes one or more processors; a machine-learned model trained to receive input data including vehicle data and passenger data and, responsive to receiving the input data, generate an output including one or more unfavorable experience predictions; and a memory including one or more computer-readable media. The memory can store computer-readable instructions that when executed by the one or more processors cause the one or more processors to perform operations. The operations can include receiving input data including vehicle data and passenger data. The vehicle data can be based at least in part on one or more states of an autonomous vehicle and the passenger data can be based at least in part on one or more sensor outputs associated with one or more states of one or more passengers of the autonomous vehicle. The operations can include sending the input data to the machine-learned model. Furthermore, the operations can include generating, based at least in part on the output from the machine-learned model, passenger experience data including one or more unfavorable experience predictions associated with one or more unfavorable experiences by the one or more passengers.

Another example aspect of the present disclosure is directed to an autonomous vehicle including one or more processors and a memory including one or more computer-readable media. The memory can store computer-readable instructions that when executed by the one or more processors can cause the one or more processors to perform operations. The operations include receiving vehicle data and passenger data. The vehicle data can be based at least in part on one or more states of an autonomous vehicle and the passenger data can be based at least in part on one or more sensor outputs associated with one or more states of one or more passengers of the autonomous vehicle. The operations can include, responsive to the passenger data satisfying one or more passenger experience criteria, determining that one or more unfavorable experiences by the one or more passengers have occurred. The one or more passenger experience criteria can specify one or more unfavorable states associated with the one or more passengers. Further, the operations can include generating passenger experience data based at least in part on the vehicle data and the passenger data at the one or more time intervals associated with the one or more unfavorable experiences by the one or more passengers.

Other example aspects of the present disclosure are directed to other systems, methods, vehicles, apparatuses, tangible non-transitory computer-readable media, and devices for monitoring the state of an autonomous vehicle and a passenger of an autonomous vehicle. These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system according to example embodiments of the present disclosure;

FIG. 2 depicts an example of an environment including a biometrically monitored vehicle according to example embodiments of the present disclosure;

FIG. 3 depicts an example of biometric computing device according to example embodiments of the present disclosure;

FIG. 4 depicts an example of generating a feedback query on a computing device according to example embodiments of the present disclosure;

FIG. 5 depicts a flow diagram of an example method of determining a passenger experience according to example embodiments of the present disclosure;

FIG. 6 depicts a flow diagram of an example method of determining a passenger experience according to example embodiments of the present disclosure;

FIG. 7 depicts a flow diagram of an example method of determining a passenger experience according to example embodiments of the present disclosure;

FIG. 8 depicts a flow diagram of an example method of determining a passenger experience according to example embodiments of the present disclosure;

FIG. 9 depicts a flow diagram of an example method of determining a passenger experience according to example embodiments of the present disclosure;

FIG. 10 depicts a flow diagram of an example method of determining a passenger experience according to example embodiments of the present disclosure; and

FIG. 11 depicts an example system according to example embodiments of the present disclosure.

### DETAILED DESCRIPTION

Example aspects of the present disclosure are directed to determining the state (e.g., physiological state) of passengers during operation of a vehicle (e.g., an autonomous vehicle, a semi-autonomous vehicle, or a manually operated vehicle). In particular, aspects of the present disclosure include a computing system (e.g., a vehicle computing system including one or more computing devices that can be configured to monitor and/or control one or more vehicle systems) that can receive data associated with the state of one or more passengers of a vehicle (e.g., passenger heart rate, blood pressure, and/or gaze direction) and/or the state of the vehicle (e.g., velocity, acceleration, and or vehicle system state); determine when an unfavorable experience (e.g., an experience that is unpleasant and/or uncomfortable for a passenger of the vehicle) has occurred; and generate data (e.g., passenger experience data in the form of a data structure including information associated with the state of the one or more passengers and the vehicle) which can be used to determine the experience of the one or more passengers.

By way of example, a vehicle computing system can receive sensor data from one or more sensors (e.g., one or more biometric sensors worn by the one or more passengers and one or more vehicle system sensors that detect motion characteristics of the vehicle) as a vehicle travels on a road. For example, the vehicle computing system can use one or more physiological state determination techniques (e.g., rules based techniques and/or using a machine-learned model) to determine when an unfavorable experience is occurring to one or more passengers of a vehicle based on one or more physiological states (e.g., heart rate, blood pressure, and/or blink rate) of the one or more passengers in response to one or more states of the vehicle that result from various vehicle activities (e.g., excessive acceleration, excessive braking, and/or sudden turning movements). Further, the computing system can use the state of the one or more passengers and/or the state of the vehicle to generate a data structure that includes passenger experience data associating the state of the vehicle with occurrence of the unfavorable experience by the one or more passengers and other states that may be occurring at the same time (e.g., the state of the environment external to the vehicle including the proximity of other objects to the vehicle).

Furthermore, the passenger experience data can be used to specify the state of the vehicle and the one or more passengers when the unfavorable experience is determined to occur. For example, the passenger experience data can specify the velocity, acceleration, vehicle passenger compartment temperature, vehicle compartment visibility of the vehicle; and the heart rate, blood pressure, and pupillary dilation of the one or more passengers. As such, the passenger experience data can be used to determine performance characteristics of the vehicle that correspond to an unfavorable experience for a passenger and which can be used to provide an improved passenger experience (e.g., fewer and/or less pronounced unfavorable experiences for passengers of the vehicle).

The disclosed technology can include a vehicle computing system (e.g., one or more computing devices that includes one or more processors and a memory) that can process, generate, and/or exchange (e.g., send and/or receive) signals or data, including signals or data exchanged with various devices including one or more vehicles, vehicle components (e.g., engine, brakes, steering, and/or transmission), and/or remote computing devices (e.g., one or more smart phones and/or wearable devices). For example, the vehicle computing system can exchange one or more signals (e.g., electronic signals) or data with one or more vehicle systems including biometric monitoring systems (e.g., one or more heart rate sensors, blood pressure sensors, galvanic skin response sensors, and/or pupillary dilation sensors); passenger compartment systems (e.g., cabin temperature systems, cabin ventilation systems, and/or seat sensors); vehicle access systems (e.g., door, window, and/or trunk systems); illumination systems (e.g., headlights, internal lights, signal lights, and/or tail lights); sensor systems (e.g., sensors that generate output based on the state of the physical environment inside the vehicle and/or external to the vehicle, including one or more light detection and ranging (LIDAR) devices, cameras, microphones, radar devices, and/or sonar devices); communication systems (e.g., wired or wireless communication systems that can exchange signals or data with other devices); navigation systems (e.g., devices that can receive signals from GPS, GLONASS, or other systems used to determine a vehicle's geographical location); notification systems (e.g., devices used to provide notifications to waiting passengers, including one or more display devices, status indicator lights, or audio output systems); braking systems (e.g., brakes of the vehicle including mechanical and/or electric brakes); propulsion systems (e.g., motors or engines including internal combustion engines or electric engines); and/or steering systems used to change the path, course, or direction of travel of the vehicle.

Further, the vehicle computing system can exchange one or more signals and/or data with one or more sensor devices associated with the one or more passengers including devices that can determine the physiological or biometric state of the one or more passengers. For example, the vehicle computing system can exchange one or more signals and/or data with one or more mobile computing devices (e.g., smartphones that include one or more biometric sensors), wearable devices (e.g., one or more wearable wrist bands, eye-wear, pendants, and/or chest-straps that include one or more biometric sensors).

The vehicle computing system can receive vehicle data and passenger data. For example, the vehicle computing system can include one or more transmitters and/or receivers that are configured to send and/or receive one or more signals (e.g., signals transmitted wirelessly and/or via wire) that include the vehicle data and/or the passenger data. The vehicle data can be based at least in part on one or more states of a vehicle (e.g., physical states based on the vehicle's motion and states of the vehicle's associated vehicle systems) and the passenger data can be based at least in part on one or more sensor outputs associated with one or more states of one or more passengers (e.g., physiological states) of the autonomous vehicle.

In some embodiments, the vehicle data can be based at least in part on one or more states of the vehicle including a velocity of the autonomous vehicle, an acceleration of the autonomous vehicle, a deceleration of the autonomous vehicle, a turn direction of the vehicle (e.g., the vehicle turning left or right), a lateral force on a passenger compartment of the vehicle (e.g., lateral force on the passenger compartment when the vehicle performs a turn), a current geographic location of the vehicle (e.g., a latitude and longitude of the autonomous vehicle, an incline angle of the vehicle relative to the ground, a passenger compartment temperature of the vehicle (e.g., a temperature of the passenger compartment/cabin in Kelvin, Celsius, or Fahrenheit), a vehicle doorway state (e.g., whether a door is open or closed), and/or a vehicle window state (e.g., whether a window is open or closed).

The one or more sensor outputs associated with the one or more states of the one or more passengers can be generated by one or more sensors including one or more biometric sensors (e.g., one or more heart rate sensors, one or more electrocardiograms, one or more blood-pressure monitors), one or more image sensors (e.g., one or more cameras), one or more thermal sensors, one or more tactile sensors, one or more capacitive sensors, and/or one or more audio sensors (e.g., one or more microphones).

Further, the one or more states of the one or more passengers can include heart rate (e.g., heart beats per minute), blood pressure, grip strength, blink rate (e.g., blinks per minute), facial expression (e.g., a facial expression determined by a facial recognition system), pupillary response, skin temperature, amplitude of vocalization (e.g., loudness of vocalizations/speech by one or more passengers), frequency of vocalization (e.g., a number of vocalizations/speech per minute), and/or tone of vocalization (e.g., tone of vocalization/speech determined by a tone recognition system).

The vehicle computing system can, responsive to the passenger data satisfying one or more passenger experience criteria, determine that one or more unfavorable experiences by the one or more passengers have occurred. The one or more passenger experience criteria can specify one or more unfavorable states (e.g., physiological states of the one or more passengers that are unpleasant and/or uncomfortable for the one or more passengers) associated with the one or more passengers. For example, the one or more passenger experience criteria can specify one or more unfavorable states of the one or more passengers that are associated with physical responses (e.g., physical responses detected by a biometric device) that correspond to reports by the one or more passengers of negative stress and/or discomfort.

Satisfying the one or more passenger experience criteria can include the vehicle computing system comparing the passenger data (e.g., one or more attributes, parameters, and/or values) to the one or more passenger experience criteria including one or more corresponding attributes, parameters, and/or values. For example, the passenger data can include data associated with the blood pressure of a passenger of the vehicle. The data associated with the blood pressure can be compared to one or more passenger criteria including a blood pressure range. Accordingly, satisfying the one or more passenger experience criteria can include the blood pressure exceeding or falling below the blood pressure range.

In some embodiments, the one or more passenger experience criteria can be based at least in part on one or more threshold ranges associated with the one or more states of the one or more passengers. For example, the heart rate of a passenger in beats per minute can be used to determine whether a threshold heart rate has been exceeded. As such, a heart rate threshold of one hundred (100) beats per minute can be used as one of the one or more passenger experience criteria (e.g., a heart rate that exceeds one-hundred beats per minute can satisfy one of the one or more passenger experience criteria).

The vehicle computing system can generate data including passenger experience data that is based at least in part on the vehicle data and the passenger data at one or more time intervals associated with the one or more unfavorable experiences by the one or more passengers. The passenger experience data can include vehicle data and passenger data for the one or more time intervals and can include indicators that identify the one or more time intervals at which the vehicle computing system determined that one or more unfavorable experiences by the one or more passengers have occurred.

For example, the vehicle computing system can include the vehicle data and the passenger data for a one hour time period (e.g., the duration of a time period associated with a trip by the vehicle that begins when a passenger is picked up and ends when the passenger is dropped off) and can include identifying data that indicates that an unfavorable experience (e.g., an unfavorable experience associated with a rapidly elevated heart rate above a heart rate threshold) occurred when hard braking was performed by the vehicle at the twenty-two minute mark and that a second unfavorable experience (e.g., an unfavorable experience associated with a gasp that has an amplitude above a vocalization amplitude) occurred when a sharp left turn was performed by the vehicle at the fifty-one minute mark. Additionally, in some embodiments, portions of the passenger experience data that are not associated with the one or more unfavorable experiences by the one or more passengers can be identified as neutral experiences or positive experiences for the one or more passengers.

In some embodiments, the vehicle computing system can, responsive to the passenger data satisfying the one or more passenger experience criteria, activate one or more vehicle systems associated with operation of the autonomous vehicle. For example, the vehicle computing system can, in response to determining that the passenger data satisfies the one or more passenger experience criteria, activate one or more vehicle systems including passenger compartment systems (e.g., reducing temperature in the passenger compartment when the one or more passengers are too hot); illumination systems (e.g., turning on headlights when passenger visibility is too low); notification systems (e.g., generate an audio message asking a passenger if the passenger is comfortable); braking systems (e.g., apply braking when the vehicle is traveling to fast for the passenger's comfort); propulsion systems (e.g., reducing output from an electric motor in order to reduce vehicle velocity when a passenger is uncomfortable with the velocity); and/or steering systems (e.g., steering the vehicle away from objects with a proximity that could cause passenger discomfort).

In some embodiments, the vehicle computing system can generate one or more vehicle state criteria which can be based at least in part on the vehicle data at the one or more time intervals associated with the one or more unfavorable experiences by the one or more passengers. The one or more vehicle state criteria can include one or more states of the vehicle (e.g., velocity of the vehicle, acceleration of the vehicle, and/or geographic location of the vehicle) that can correspond to the one or more unfavorable experiences of the one or more passengers.

Further, the vehicle computing system can generate, based in part on a comparison of the vehicle data to the one or more vehicle state criteria, unfavorable experience prediction data that includes one or more predictions of an unfavorable experience at one or more time intervals subsequent to the one or more time intervals associated with the one or more unfavorable experiences by the one or more passengers.

For example, the vehicle computing system can generate one or more vehicle state criteria including velocity criteria (e.g., a velocity of one hundred and twenty kilometers per hour) that include a threshold velocity corresponding to one or more unfavorable experiences by a passenger of the vehicle at a previous time. Further, based on the occurrence of the one or more unfavorable experiences by the one or more passengers at a previous time, the vehicle computing system can generate one or more predictions that the passengers will have an unfavorable experience when the velocity exceeds the threshold velocity at a future time.

The vehicle computing system can determine, based at least in part on one or more vehicle sensor outputs from one or more vehicle sensors of the autonomous vehicle, one or more spatial relations of an environment with respect to the autonomous vehicle. The one or more spatial relations can include a location (e.g., geographic location or location relative to the vehicle), proximity (e.g., distance between the vehicle and the one or more objects), and/or position (e.g., a height and/or orientation relative to a point of reference including the vehicle) of the one or more objects (e.g., other vehicles, buildings, cyclists, and/or pedestrians) external to the autonomous vehicle. For example, the vehicle computing system can determine the proximity of one or more vehicles within range of the vehicle's sensors. When the vehicle computing system determines that one or more unfavorable experiences by the one or more passengers have occurred, the proximity to the one or more vehicles recorded in the vehicle data can be analyzed as a factor in causing an unfavorable experience to the one or more passengers. In some embodiments, the vehicle data can be based at least in part on the one or more vehicle sensor outputs.

The vehicle computing system can determine, based at least in part on the vehicle data (e.g., the vehicle data including the one or more spatial relations between the vehicle and the one or more objects), a distance between the vehicle and one or more objects (e.g., other vehicles) external to the vehicle including the distance at the one or more time intervals associated with the one or more unfavorable experiences by the one or more passengers. For example, the vehicle computing system can determine that one or more unfavorable experiences by the one or more passengers occur when the vehicle is within fifty centimeters (50 cm) of another vehicle. Further, the vehicle computing system can use the distance (50 cm) between the vehicle and another vehicle as a value (e.g., a threshold value) for one or more distance thresholds that can be compared to a current distance between the vehicle and one or more objects external to the vehicle. In some embodiments, the one or more vehicle state criteria can include one or more distance thresholds based at least in part on the one or more distances between the vehicle and the one or more objects.

The vehicle computing system can determine, based at least in part on the passenger data, one or more vocalization characteristics of the one or more passengers. For example, the passenger data can include audio data (e.g., data based on recordings from one or more microphones in the vehicle) associated with one or more sensor outputs from one or more microphones in a passenger compartment of the vehicle. The vehicle computing system can process the audio data to determine when the one or more passengers have produced one or more vocalizations and can further determine one or more vocalization characteristics of the one or more vocalizations including a timbre, pitch, frequency, amplitude, and/or duration.

The vehicle computing system can determine when the one or more vocalization characteristics satisfy one or more vocalization criteria associated with the one or more characteristics of the one or more vocalizations. For example, the vehicle computing system can determine when the one or more vocalizations are associated with an unfavorable vocalization (e.g., a sudden gasp or loud exhortation) of a plurality of unfavorable vocalizations that indicate the occurrence of an unfavorable experience. In some embodiments, satisfying the one or more passenger experience criteria can include the one or more vocalization characteristics satisfying the one or more vocalization criteria (e.g., a portion of the one or more vocalizations matching and/or corresponding to an unfavorable vocalization).

The vehicle computing system can generate a feedback query that can include a request for passenger experience feedback from the one or more passengers. The feedback query can include one or more indications including one or more audio indications and/or one or more visual indications. For example, the vehicle computing system can generate an audio indication asking a passenger of the vehicle for their current state (e.g., the vehicle computing system generating audio stating “How do you feel?” and/or “Are you okay?”). The feedback query can be generated on the vehicle (e.g., a display device of the vehicle or via speakers in the vehicle) and/or transmitted to one or more remote computing devices that can be associated with the one or more passengers (e.g., a smart phone and/or a wearable computing device). In some embodiments, the vehicle computing system can determine the gaze of a passenger to determine how the feedback query will be generated (e.g., the feedback query is sent to a passenger's smart phone when the passenger gaze is directed towards the smart phone).

The vehicle computing system can then receive passenger experience feedback (e.g., an answer to the feedback query by the one or more passengers) from the one or more passengers, which can be used as information about the reported state of the one or more passengers. The passenger experience feedback can include vocal feedback (e.g., speaking), performing a physical input (e.g., touching a touch interface and/or typing a response to the feedback query), gestures (e.g., nodding the head, shaking the head, and/or thumbs up), and/or facial expressions (e.g., smiling). In some embodiments, the passenger data can include or be based in part on the passenger experience feedback received from the one or more passengers.

The vehicle computing system can determine, based at least in part on the one or more sensor outputs, one or more movement states (e.g., movements, gestures, and/or body positions) of the one or more passengers. The one or more movement states can include a velocity of movement (e.g., how quickly one or more passengers turn their heads and/or raise their hands), frequency of movement (e.g., how often a passenger moves within a time interval), extent of movement (e.g., the range of motion of a passenger's movement), and/or type of movement (e.g., raising one or more hands, tilting of the head, moving one or more legs, and/or leaning of the torso) of movement by the one or more passengers. For example, the vehicle computing system can determine when a passenger suddenly raises their hands in front of their body, which upon comparison to the one or more passenger experience criteria can be determined to be a movement associated with an unfavorable experience by a passenger. In some embodiments, the passenger data can be based at least in part on the one or more movement states of the one or more passengers.

The vehicle computing system can determine, based at least in part on the vehicle data or the passenger data, passenger visibility which can include the visibility to the one or more passengers of the environment external to autonomous vehicle. The passenger visibility can be based in part on sensor outputs from one or more sensors that detect the one or more states of the vehicle, the one or more states of the one or more passengers, and/or the one or more states of the environment external to the vehicle.

For example, the one or more sensor outputs used to determine the passenger visibility can detect one or more states including the states of the one or more passengers pupils (e.g., greater pupil dilation can correspond to less light and lower visibility); the states of the one or more passengers eyelids (e.g., the eyelid openness and/or shape of the one or more passengers); an intensity and/or amount of light entering the passenger compartment of the vehicle (e.g., sunlight, moonlight, lamplight, and/or headlight beams from other vehicles); an intensity and/or amount of light generated by the vehicle headlights and/or passenger compartment lights; an amount of precipitation external to the vehicle (e.g., rain, snow, fog, and/or hail); and/or the unobstructed visibility distance (e.g., the distance a passenger can see before their vision is obstructed by an object including a building, foliage, signage, other vehicles, natural features, and/or pedestrians).

Furthermore, the vehicle computing system can adjust, based at least in part on the passenger visibility, a weighting of the one or more states of the passenger data used to satisfy the one or more passenger experience criteria. For example, a lower passenger visibility can increase the weighting of pupillary response and/or eyelid openness from the one or more passengers. Accordingly, passenger states including narrowed eyelids and dilated pupils can, under low visibility conditions, be more heavily weighted in the determination of whether one or more unfavorable experiences by the one or more passengers have occurred.

In some embodiments, the passenger visibility can be based at least in part on one or more states of the environment external to the vehicle including weather conditions (e.g., rain, snow, fog, or sunshine), time of day (e.g., dusk, dawn, midday, day-time, or night-time), traffic density (e.g., a number of vehicles, cyclists, and/or pedestrians within an area), foliage density (e.g., the amount of foliage in an area including trees, plants, and/or bushes), or building density (e.g., the amount of buildings within an area).

In some embodiments, the vehicle computing system can include a machine-learned model (e.g., a machine-learned passenger state model) that is trained to receive input data comprising vehicle data and/or passenger data and, responsive to receiving the input data, generate an output that can include passenger experience data that includes one or more unfavorable experience predictions associated with one or more unfavorable experiences by the one or more passengers. Further, the vehicle computing system can receive sensor data from one or more sensors associated with an autonomous vehicle. The sensor data can include information associated with one or more states of objects including a vehicle (e.g., vehicle velocity, vehicle acceleration, one or more vehicle system states, and/or vehicle path) and one or more states of a passenger of the vehicle (e.g., one or more visual or sonic states of the passenger).

The input data can be sent to the machine-learned model which can process the sensor data and generate an output (e.g., classified sensor outputs). The vehicle computing system can generate, based at least in part on output from the machine-learned model, one or more detected passenger predictions that can be associated with one or more detected visual or sonic states of the one or more passengers including one or more facial expressions (e.g., smiling, frowning, and/or yawning), one or more bodily gestures (e.g., raising one or more arms, tapping a foot, and/or turning a head), and/or one or more vocalizations (e.g., speaking, raising the voice, sighing, and/or whispering). In some embodiments, the vehicle computing system can activate one or more vehicle systems (e.g., motors, engines, brakes, and/or steering) based at least in part on the one or more detected object predictions.

The vehicle computing system can access a machine-learned model that has been generated and/or trained in part using training data including a plurality of classified features and a plurality of classified object labels. In some embodiments, the plurality of classified features can be extracted from one or more images each of which include a representation of one or more passenger states (e.g., raised arm, tapping foot, body leaning to one side, smiling face, uncomfortable face, and/or apprehensive face) in which the representation is based at least in part on output from one or more image sensor devices (e.g., one or more cameras). Further, the plurality of classified features can be extracted from one or more sounds (e.g., recorded audio) each of which includes a representation of one or more words, phrases, expressions, and/or tones of voice in which the representation is based at least in part on output from one or more audio sensor devices (e.g., one or more microphones).

When the machine-learned model has been trained, the machine-learned model can associate the plurality of classified features with one or more classified object labels that are used to classify or categorize objects including objects that are not included in the plurality of training objects (e.g., a phrase spoken by a person not included in the plurality of training objects can be recognized using the machine-learned model). In some embodiments, as part of the process of training the machine-learned model, the differences in correct classification output between a machine-learned model (that outputs the one or more classified object labels) and a set of classified object labels associated with a plurality of training objects that have previously been correctly identified (e.g., ground truth labels), can be processed using an error loss function that can determine a set of probability distributions based on repeated classification of the same plurality of training objects. As such, the effectiveness (e.g., the rate of correct identification of objects) of the machine-learned model can be improved over time.

The vehicle computing system can access the machine-learned model in a variety of ways including exchanging (sending and/or receiving via a network) data or information associated with a machine-learned model that is stored on a remote computing device; and/or accessing a machine-learned model that is stored locally (e.g., in one or more storage devices of the vehicle).

The plurality of classified features can be associated with one or more values that can be analyzed individually and/or in various aggregations. Analysis of the one or more values associated with the plurality of classified features can include determining a mean, mode, median, variance, standard deviation, maximum, minimum, and/or frequency of the one or more values associated with the plurality of classified features. Further, processing and/or analysis of the one or more values associated with the plurality of classified features can include comparisons of the differences or similarities between the one or more values. For example, the one or more facial expression images and sounds associated with a passenger having an unfavorable experience can be associated with a range of images and sounds that are different from the range of images and sounds associated with a passenger that is not having an unfavorable experience.

In some embodiments, the plurality of classified features can include a range of sounds associated with the plurality of training objects, a range of temperatures associated with the plurality of training objects, a range of velocities associated with the plurality of training objects, a range of accelerations associated with the plurality of training objects, a range of colors associated with the plurality of training objects, a range of shapes associated with the plurality of training objects, physical dimensions (e.g., length, width, and/or height) of the plurality of training objects. The plurality of classified features can be based at least in part on the output from one or more sensors that have captured a plurality of training objects (e.g., actual objects used to train the machine-learned model) from various angles and/or distances in different environments (e.g., construction noise, music playing, traffic noise, well-lit passenger compartment, dimly lit passenger compartment, passenger compartment with cargo, and/or crowded passenger compartment) and/or environmental conditions (e.g., bright sunlight, rain, overcast conditions, darkness, and/or thunder storms). The one or more classified object labels, that can be used to classify or categorize the one or more objects, can include facial expressions (e.g., smiling, frowning, pensive, and/or surprised), words (e.g., “stop”), phrases (e.g., “please slow down the vehicle”), vocalization expressions, vocalization tones, vocalization amplitudes, and/or vocalization frequency (e.g., the number of vocalizations per minute).

The machine-learned model can be generated based at least in part on one or more classification processes or classification techniques. The one or more classification processes or classification techniques can include one or more computing processes performed by one or more computing devices based at least in part on sensor data associated with physical outputs from a sensor device. The one or more computing processes can include the classification (e.g., allocation or sorting into different groups or categories) of the physical outputs from the sensor device, based at least in part on one or more classification criteria (e.g., a size, shape, color, velocity, acceleration, and/or sound associated with an object). In some embodiments, the machine-learned model can include a convolutional neural network, a recurrent neural network, a recursive neural network, gradient boosting, a support vector machine, and/or a logistic regression classifier.

The vehicle computing system can determine, based in part on the passenger experience data, a number of the one or more unfavorable experiences by the one or more passengers that have occurred. For example, the vehicle computing system can increment an unfavorable experience counter by one after each occurrence of the one or more unfavorable experiences within a predetermined time period. In this way, the unfavorable experience counter can be used to track the number of the one or more unfavorable experiences.

Furthermore, the vehicle computing system can adjust, based at least in part on the number of the one or more unfavorable experiences by the one or more passengers that have occurred, one or more threshold ranges associated with the one or more passenger experience criteria. For example, a loudness threshold of one or more vocalizations by the one or more passengers can be reduced when the number of unfavorable experiences by the one or more passengers exceeds one unfavorable experience in a fifteen minute period. As such, the passenger experience criterion for an unfavorable experience can be more easily satisfied as the number of unfavorable experiences increases.

Additionally, the vehicle computing system can determine an unfavorable experience rate based on the number of the one or more unfavorable experiences in a time period (e.g., a predetermine time period). The unfavorable experience rate can also be used to adjust the one or more threshold ranges associated with the one or more passenger experience criteria (e.g., a lower unfavorable experience rate can set the one or more passenger experience criteria to a default value and a higher unfavorable experience rate can decrease the one or more threshold ranges associated with the one or more passenger experience criteria).

The vehicle computing system can determine an accuracy level of the passenger experience data based at least in part on a comparison of the passenger experience data to ground-truth data associated with one or more previously recorded unfavorable experiences (e.g., previously recorded unfavorable experiences reported by one or more previous passengers and/or one or more biometric passenger biometric states associated with confirmed unfavorable passenger experiences) and one or more previously recorded vehicle states (e.g., one or more previously recorded vehicle states from a time interval when one or more unfavorable passenger experiences occurred). For example, the ground-truth data can include one or more previously reported (e.g., previously reported by passengers of a vehicle) unfavorable experiences to which the passenger experience data can be compared in order to determine one or more differences in the one or more states of the passengers to one or more previously reported states of passengers reported in the ground-truth data.

Furthermore, the vehicle computing system can adjust, based at least in part on the accuracy level, the one or more passenger experience criteria based at least in part on differences (e.g., the number of differences, the type of differences, and/or the magnitude of differences) between the passenger experience data and the ground-truth data. In some embodiments, the weighting of the one or more passenger experience criteria can be adjusted based on a comparison of the determined occurrence of one or more unfavorable experiences by the one or more passengers in the unfavorable experience data and reported unfavorable experience data based in part on the passenger experience feedback.

For example, a vehicle filled with a sample group of passengers including loud and voluble passengers on their way to a birthday party can result in passenger data that includes one or more sound states (e.g., sudden shouting and exclamations) that corresponds to an unfavorable occurrence. The passengers states can also include one or more visual states (e.g., smiling and happy faces) that do not correspond to an unfavorable occurrence. When the passengers are dropped off, the vehicle computing system can generate a feedback query asking the passengers for passenger experience feedback about their experience to which the passengers could report a positive experience.

The passenger experience feedback from the sample group can be compared to ground-truth data which may not be based on groups that produce the same states as the sample group. Based on the differences between the passenger experience data and the ground-truth data, the passenger experience criteria can be adjusted (e.g., the passenger experience criteria will be weighted so that the types of passenger states in the sample group will be less likely to trigger the determination that an unfavorable passenger experience has occurred) to more accurately determine the occurrence of unfavorable passenger experiences.

In some embodiments, the vehicle computing system can perform one or more operations including determining one or more gaze characteristics of the one or more passengers. The vehicle computing system can include one or more sensors (e.g., cameras) that can be used to track the movement of the one or more passengers (e.g., track the movement of the head, face, eyes, and/or body of the one or more passengers) and generate one or more signals or data that can be processed by a gaze detection or gaze determination system of the vehicle computing system (e.g., a machine-learned model that has been trained to determine the direction and duration of a passenger's gaze).

In some embodiments, the one or more gaze characteristics can be used to satisfy one or more gaze characteristics. For example, the vehicle computing system can determine that a passenger of the vehicle has been gazing through a rear window of the vehicle for a duration that exceeds a gaze duration threshold associated with an unfavorable passenger experience. As such, prolonged gazing through the rear window can be indicative of passenger discomfort (e.g., another vehicle to the rear of the vehicle carrying the passenger may be too close). In some embodiments, satisfying the one or more passenger experience criteria can include the one or more gaze characteristics satisfying one or more gaze characteristics comprising a direction and/or duration of one or more gazes by the one or more passengers.

The vehicle computing system can compare the state of the one or more passengers when the vehicle is traveling (e.g., the vehicle is in motion) to the state of the one or more passengers when the vehicles not traveling (e.g., the vehicle is stationary). The one or more states of a passenger can be determined when the passenger enters the vehicle and before the vehicle starts traveling. The state of the passenger before the vehicle starts traveling can be used as a baseline value from which a threshold value can be determined.

For example, the baseline heart rate of a passenger can be seventy (70) beats per minute upon entering a vehicle and before the vehicle starts traveling. The vehicle computing system can then determine a threshold heart rate that is double the baseline heart rate (i.e., one hundred and forty beats per minute) or fifty percent greater (i.e., one hundred and five beats per minute) than the baseline heart rate. In this example, the one or more passenger criteria can be based at least in part on the difference between the baseline heart rate and the threshold heart rate. In some embodiments, the one or more passenger experience criteria can be based at least in part on one or more differences between the state of one or more passengers when the vehicle is traveling and the state of the one or more passengers when the vehicle is not traveling.

The systems, methods, and devices in the disclosed technology can provide a variety of technical effects and benefits. In particular, the disclosed technology can provide numerous benefits including improvements in the areas of safety, energy conservation, passenger comfort, and vehicle component longevity. The disclosed technology can improve passenger safety by determining the vehicle states (e.g., velocity, acceleration, and turning characteristics) that correspond to an improved level of safety (e.g., less physiological stress) for a passenger of a vehicle. For example, a passenger of a vehicle can have a medical condition (e.g., high blood pressure, or an injured limb) that can result in harm to the passenger when the passenger is subjected to high acceleration or sharp turns by a vehicle. By determining a range of vehicle states (e.g., a range of velocities and/or accelerations) that can decrease the risk of harming the passenger (i.e., improve the safety of the passenger by avoiding harmful vehicle states), the disclosed technology can improve the safety of one or more passengers in the vehicle.

Further, the disclosed technology can improve the overall passenger experience by identifying the states of a passenger and/or a vehicle associated with passenger discomfort or unease. For example, a passenger heart rate exceeding one hundred beats per minute can be associated with the occurrence of an unfavorable passenger experience. As such, by monitoring the heart rate of a passenger, the vehicle can perform (e.g., accelerate and/or turn) in a manner that keeps the passenger heart rate below one hundred beats per minute. Additionally, certain types of vehicle actions (e.g., hard left turns and/or sudden acceleration) may be associated with the occurrence of an unfavorable passenger experience.

Accordingly, the vehicle can be configured to avoid the types of vehicle actions (e.g., hard left turns) that result in the unfavorable passenger experience. Additionally, better identification of vehicle states that result in passenger discomfort can in some instances result in more effective use of vehicle systems. For example, passenger comfort may be associated with a range of accelerations that is lower and potentially more fuel efficient. As such, lower acceleration can result in both fuel savings and greater passenger comfort.

Further, the disclosed technology can also more optimally determine the occurrence of an unfavorable experience by a passenger, which can be used to reduce the number of vehicle stoppages due to passenger discomfort. For example, a passenger in a vehicle that does not use passenger experience data to adjust its performance (e.g., acceleration and/or turning) can be more prone to request vehicle stoppage, which can result in less efficient of energy that results from more frequent acceleration following a vehicle stoppage. As such, reducing the number of stoppages of a vehicle due to passenger discomfort can result in more efficient energy usage through decreased occurrences of accelerating the vehicle from a stop.

Furthermore, the disclosed technology can improve the longevity of the vehicle's components by determining vehicle states that correspond to an unfavorable experience for a passenger of the vehicle and generating data that can be used to moderate the vehicle states that strain vehicle components and cause an unfavorable experience for the passenger. For example, sharp turns that accelerate wear and tear on a vehicle's wheels and steering components can correspond to an unfavorable experience for a passenger. By generating data indicating a less sharp turn for the passenger, the vehicle's wheels and steering components can undergo less strain and last longer.

Accordingly, the disclosed technology can provide more effective determination of an unfavorable passenger experience through improvements in passenger safety, energy conservation, passenger comfort, and vehicle component longevity, as well as allowing for improved performance of other vehicle systems that can benefit from a closer correspondence between a passenger's comfort and the vehicle's state.

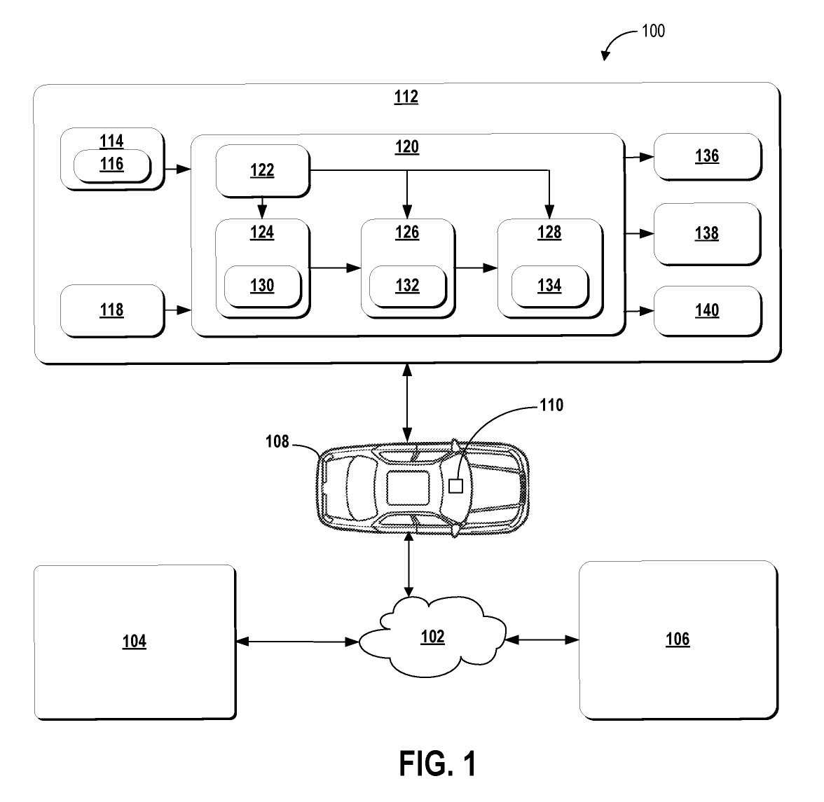

With reference now to FIGS. 1-11, example embodiments of the present disclosure will be discussed in further detail. FIG. 1 depicts a diagram of an example system 100 according to example embodiments of the present disclosure. As illustrated, FIG. 1 shows a system 100 that includes a communication network 102; an operations computing system 104; one or more remote computing devices 106; a vehicle 108; one or more passenger compartment sensors 110; a vehicle computing system 112; one or more sensors 114; sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider that can provide one or more vehicle services to a plurality of users via a fleet of vehicles that includes, for example, the vehicle 108. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 108. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of a vehicle including receiving vehicle data and passenger data from a vehicle (e.g., the vehicle 108) or one or more remote computing devices, determining whether the passenger data satisfies one or more passenger experience criteria, generating passenger experience data based at least in part on the vehicle data and the passenger data, and/or activating one or more vehicle systems.

For example, the operations computing system 104 can be configured to monitor and communicate with the vehicle 108 and/or its users to coordinate a vehicle service provided by the vehicle 108. To do so, the operations computing system 104 can manage a database that includes data including vehicle status data associated with the status of vehicles including the vehicle 108; and/or passenger status data associated with the status of passengers of the vehicle. The vehicle status data can include a location of a vehicle (e.g., a latitude and longitude of a vehicle), the availability of a vehicle (e.g., whether a vehicle is available to pick-up or drop-off passengers and/or cargo), or the state of objects external to a vehicle (e.g., the physical dimensions and/or appearance of objects external to the vehicle). The passenger status data can include one or more states of passengers of the vehicle including biometric or physiological states of the passengers (e.g. heart rate, blood pressure, and/or respiratory rate).

The operations computing system 104 can communicate with the one or more remote computing devices 106 and/or the vehicle 108 via one or more communications networks including the communications network 102. The communications network 102 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 102 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 108.

Each of the one or more remote computing devices 106 can include one or more processors and one or more memory devices. The one or more memory devices can be used to store instructions that when executed by the one or more processors of the one or more remote computing devise 106 cause the one or more processors to perform operations and/or functions including operations and/or functions associated with the vehicle 108 including exchanging (e.g., sending and/or receiving) data or signals with the vehicle 108, monitoring the state of the vehicle 108, and/or controlling the vehicle 108. The one or more remote computing devices 106 can communicate (e.g., exchange data and/or signals) with one or more devices including the operations computing system 104 and the vehicle 108 via the communications network 102. For example, the one or more remote computing devices 106 can request the location of the vehicle 108 via the communications network 102.

The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the vehicle 108 including a location (e.g., a latitude and longitude), a velocity, acceleration, a trajectory, and/or a path of the vehicle 108 based in part on signals or data exchanged with the vehicle 108. In some implementations, the operations computing system 104 can include the one or more remote computing devices 106.

The vehicle 108 can be a ground-based vehicle (e.g., an automobile), an aircraft, and/or another type of vehicle. The vehicle 108 can be an autonomous vehicle that can perform various actions including driving, navigating, and/or operating, with minimal and/or no interaction from a human driver. The autonomous vehicle 108 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 108 can provide driving and navigational operation with minimal and/or no interaction from a human driver present in the vehicle. A semi-autonomous operational mode can be one in which the vehicle 108 can operate with some interaction from a human driver present in the vehicle. Park and/or sleep modes can be used between operational modes while the vehicle 108 performs various actions including waiting to provide a subsequent vehicle service, and/or recharging between operational modes.

Furthermore, the vehicle 108 can include the one or more passenger compartment sensors 110 which can include one or more devices that can detect and/or determine one or more states of one or more objects inside the vehicle including one or more passengers. The one or more passenger compartment sensors 110 can be based in part on different types of sensing technology and can be configured to detect one or more biometric or physiological states of objects inside the vehicle including heart rate, blood pressure, and/or respiratory rate.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the vehicle 108. Furthermore, the vehicle 108 can provide data indicative of the state of the one or more objects (e.g., physical dimensions and/or appearance of the one or more objects) within a predefined distance of the vehicle 108 to the operations computing system 104, which can store an indication, record, and/or other data indicative of the state of the one or more objects within a predefined distance of the vehicle 108 in one or more memory devices associated with the operations computing system 104 (e.g., remote from the vehicle).

The vehicle 108 can include and/or be associated with the vehicle computing system 112. The vehicle computing system 112 can include one or more computing devices located onboard the vehicle 108. For example, the one or more computing devices of the vehicle computing system 112 can be located on and/or within the vehicle 108. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 108 (e.g., its computing system, one or more processors, and other devices in the vehicle 108) to perform operations and functions, including those described herein for determining user device location data and controlling the vehicle 108 with regards to the same.

As depicted in FIG. 1, the vehicle computing system 112 can include the one or more sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more sensors 114 can be configured to generate and/or store data including the sensor data 116 associated with one or more objects that are proximate to the vehicle 108 (e.g., within range or a field of view of one or more of the one or more sensors 114). The one or more sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The sensor data 116 can include image data, radar data, LIDAR data, and/or other data acquired by the one or more sensors 114. The one or more objects can include, for example, pedestrians, vehicles, bicycles, and/or other objects. The one or more objects can be located on various parts of the vehicle 108 including a front side, rear side, left side, right side, top, or bottom of the vehicle 108. The sensor data 116 can be indicative of locations associated with the one or more objects within the surrounding environment of the vehicle 108 at one or more times. For example, sensor data 116 can be indicative of one or more LIDAR point clouds associated with the one or more objects within the surrounding environment. The one or more sensors 114 can provide the sensor data 116 to the autonomy computing system 120.

In addition to the sensor data 116, the autonomy computing system 120 can retrieve or otherwise obtain data including the map data 122. The map data 122 can provide detailed information about the surrounding environment of the vehicle 108. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 108. The positioning system 118 can be any device or circuitry for analyzing the position of the vehicle 108. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 108 can be used by various systems of the vehicle computing system 112 and/or provided to one or more remote computing devices (e.g., the operations computing system 104 and/or the remote computing device 106). For example, the map data 122 can provide the vehicle 108 relative positions of the surrounding environment of the vehicle 108. The vehicle 108 can identify its position within the surrounding environment (e.g., across six axes) based at least in part on the data described herein. For example, the vehicle 108 can process the sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 108 and determine a motion plan for controlling the motion of the vehicle 108 accordingly. For example, the autonomy computing system 120 can receive the sensor data 116 from the one or more sensors 114, attempt to determine the state of the surrounding environment by performing various processing techniques on the sensor data 116 (and/or other data), and generate an appropriate motion plan through the surrounding environment. The autonomy computing system 120 can control the one or more vehicle control systems 138 to operate the vehicle 108 according to the motion plan.

The autonomy computing system 120 can identify one or more objects that are proximate to the vehicle 108 based at least in part on the sensor data 116 and/or the map data 122. For example, the perception system 124 can obtain state data 130 descriptive of a current and/or past state of an object that is proximate to the vehicle 108. The state data 130 for each object can describe, for example, an estimate of the object's current and/or past: location and/or position; speed; velocity; acceleration; heading; orientation; size/footprint (e.g., as represented by a bounding shape); class (e.g., pedestrian class vs. vehicle class vs. bicycle class), and/or other state information. The perception system 124 can provide the state data 130 to the prediction system 126 (e.g., for predicting the movement of an object).

The prediction system 126 can generate prediction data 132 associated with each of the respective one or more objects proximate to the vehicle 108. The prediction data 132 can be indicative of one or more predicted future locations of each respective object. The prediction data 132 can be indicative of a predicted path (e.g., predicted trajectory) of at least one object within the surrounding environment of the vehicle 108. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 108 based at least in part on the prediction data 132 (and/or other data). The motion plan data 134 can include vehicle actions with respect to the objects proximate to the vehicle 108 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 108 can perform a certain action (e.g., pass an object) without increasing the potential risk to the vehicle 108 and/or violating any traffic laws (e.g., speed limits, lane boundaries, signage). The motion plan data 134 can include a planned trajectory, velocity, acceleration, and/or other actions of the vehicle 108.

The motion planning system 128 can provide the motion plan data 134 with data indicative of the vehicle actions, a planned trajectory, and/or other operating parameters to the vehicle control systems 138 to implement the motion plan data 134 for the vehicle 108. For instance, the vehicle 108 can include a mobility controller configured to translate the motion plan data 134 into instructions. By way of example, the mobility controller can translate a determined motion plan data 134 into instructions for controlling the vehicle 108 including adjusting the steering of the vehicle 108 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 106 and/or one or more other remote computing devices (e.g., the one or more remote computing devices 106) over one or more networks (e.g., via one or more wireless signal connections). In some implementations, the communications system 136 can allow communication among one or more of the system on-board the vehicle 108. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop and/or smartphone) can be viewable by a user of the vehicle 108 that is located in the front of the vehicle 108 (e.g., driver's seat, front passenger seat). Additionally, or alternatively, a display device can be viewable by a user of the vehicle 108 that is located in the rear of the vehicle 108 (e.g., a back passenger seat).

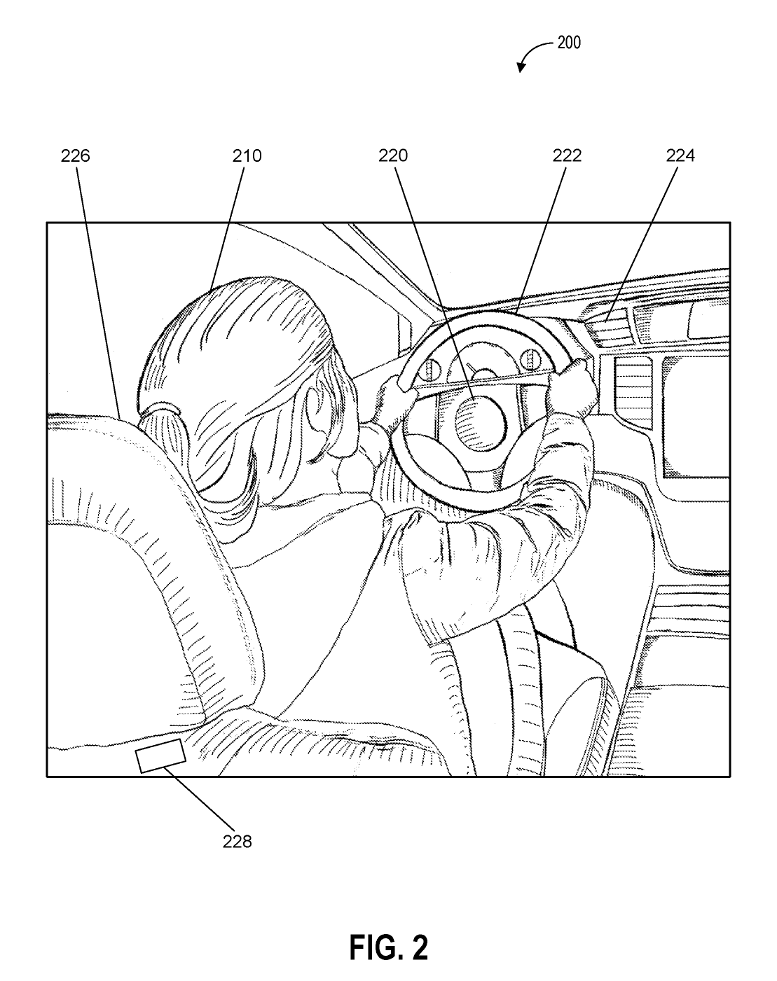

FIG. 2 depicts an example of an environment including a passenger compartment of an autonomous vehicle according to example embodiments of the present disclosure. One or more functions or operations performed in FIG. 2 can be implemented or performed by one or more devices (e.g., one or more computing devices) or systems including, for example, the vehicle 104, the vehicle computing system 108, and/or the operations computing system 150, shown in FIG. 1. As illustrated, FIG. 2 shows an environment 200 that includes a passenger 210, an image sensor 220, a grip sensor 222, a sound sensor 224, a seat 226, and a seat sensor 228.

The environment 200 includes a passenger compartment of a vehicle (e.g., the vehicle 108) that is occupied by the passenger 210. The environment 200 can include one or more of the image sensor 220 (e.g., a camera) that can be used to detect objects in the vehicle and determine one or more states of the objects including one or more biometric or physiological states of the passenger 210. For example, the image sensor 220 can generate sensor outputs that can be used to determine one or more physical dimensions of the passenger 210 (e.g., height, girth, and/or arm length); one or more physical positions of the passenger 210 (e.g., whether the passenger 210 is seated); one or more characteristics of the eyes of the passenger 210 (e.g., pupillary dilation); and/or one or more facial expressions of the passenger 210 (e.g., smiling, frowning, grimacing, and/or startled).

The environment 200 can also include the grip sensor 222 that can be used to determine whether the passenger 210 is touching (e.g., gripping) the grip sensor 222 and/or the amount of pressure being exerted by the passenger 210 on the grip sensor 222. For example, as the passenger 210 travels inside a vehicle, the grip sensor 222 can detect varying grip pressure by the passenger 210 in response to conditions outside the vehicle in which the passenger 210 is travelling. The grip sensor 222 can be located at various locations within the environment 200 including any surface within the environment 200 (e.g., doors, door handles, center console, windows, passenger compartment ceiling, and/or seats).

Furthermore, the environment 200 can include one or more sound of the sound sensor 224 (e.g., a microphone) that can detect sound including one or more sounds produced by the passenger 210. For example, the sound sensor 224 can detect when the passenger 210 speaks, laughs, and/or sighs and can be used to determine the state of the passenger 210 based on one or more characteristics of one or more sounds produced by the passenger 210 including vocalizations and other sounds including percussive sounds (e.g., the passenger 210 tapping a finger or foot on a surface of the environment 200). The sound sensor 224 can be located at various locations within the environment 200 including any surface within the environment 200 (e.g., doors, windows, and/or seats).

The environment 200 can include one or more seats (e.g., one or more front seats and/or one or more rear seats) that can be occupied by objects including one or more passengers and/or cargo. In this example, the passenger 210 is seated in the seat 226, which can include one or more seat sensors including the seat sensor 228. The seat sensor 228 can include one or more sensors that can be used to determine one or more states of a passenger occupying (e.g., sitting, kneeling, or lying down on a portion of the seat) the seat. The one or more sensors can include one or more image sensors (e.g., one or more sensors that detect light on the surface of the seat 226), one or more pressure sensors (e.g., one or more sensors that detect a mass or weight on a portion of the seat 226), one or more tactile sensors (e.g., one or more resistive or capacitive sensors), and/or one or more thermal sensors (e.g., one or more sensors that can detect heat including the body heat of a passenger). Further, the one or more sensors of the seat sensor 228 can be located in various positions including on the surface of the seat 226, inside the seat 228, and/or with portions of the seat sensor inside and external to the seat 226.

The seat sensor 228 can be used to determine one or more states of the passenger 210 including the mass of the passenger 210, the weight of the passenger 210, and/or the position and/or location of the passenger 210 with respect to the seat (e.g., sitting down in the seat 226, rising from the seat 226, and/or shifting in the seat 226). Further, the seat sensor 228 can be used to detect and/or determine one or more movements by the passenger 210 in the seat 226 including the direction, frequency, and extent of the one or more movements.

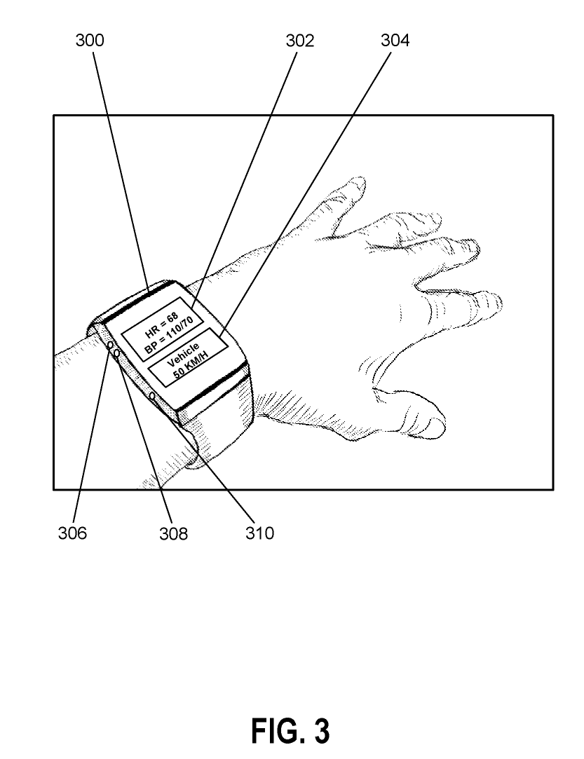

FIG. 3 depicts an example of a remote computing device generating indications based on sensors in the remote computing device and the autonomous vehicle according to example embodiments of the present disclosure. One or more actions or events depicted in FIG. 3 can be implemented by one or more devices (e.g., one or more computing devices) or systems including, for example, the vehicle 104, the vehicle computing system 108, and/or the operations computing system 150, shown in FIG. 1. FIG. 3 includes an illustration of a remote computing device 300 that can be used to exchange (e.g., send and/or receive) one or more signals or data with one or more computing systems including, for example, the vehicle 104, the vehicle computing system 108, or the operations computing system 150, shown in FIG. 1. As shown, FIG. 3 illustrates the remote computing device 300, a passenger state indication 302, a vehicle state indication 304, a biometric sensor 306, a motion sensor 308, and a communication component 310.

As shown, the remote computing device 300 is a computing device (e.g., a computing device with one or more processors and one or more memory devices) that can include one or more sensors (e.g., a heart rate and/or blood pressure sensor in the remote computing device 300) including the biometric sensor 306, that can detect one or more states of a passenger (e.g., the passenger 210) of a vehicle (e.g., the vehicle 108). The biometric sensor 306 can detect and/or determine various states of a passenger including one or more biometric or physiological states (e.g., heart rate and/or blood pressure). As illustrated, the passenger state indication 302 indicates that the passenger's heart rate is sixty-eight (68) beats per minute and that the passenger's blood pressure is one hundred and ten over seventy (110/70). The information from the biometric sensor 306 can be stored locally on the remote computing device 300 and/or exchanged (e.g., sent and/or received) with another computing device (e.g., the vehicle computing system 112) via the communication component 310.

Additionally, the remote computing device 300 can include a motion sensor 308 that can include a gyroscope and/or one or more accelerometers. The motion sensor 308 can generate one or more sensor outputs associated with movements by a passenger. For example, the motion sensor 308 can detect when a passenger of a vehicle is moving, still (i.e., not moving), raising a hand, and/or making a gesture. The information from the motion sensor 308 can be stored locally on the remote computing device 300 and/or exchanged (e.g., sent and/or received) with another computing device (e.g., the vehicle computing system 112) via the communication component 310.

Furthermore, the remote computing device 300 can be used to indicate one or more states of a vehicle in which a passenger associated with the remote computing device 300 is traveling. For example, the remote computing device can display the vehicle state indication 304 (“Vehicle 50 KM/H”) which indicates the velocity of the vehicle in which the passenger is traveling.

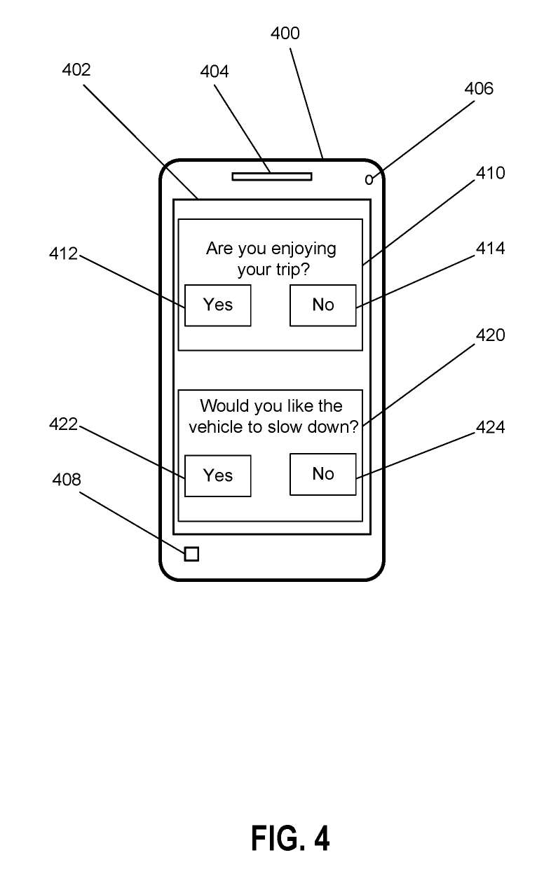

FIG. 4 depicts an example of a remote computing device receiving indications from an autonomous vehicle according to example embodiments of the present disclosure. One or more actions or events depicted in FIG. 4 can be implemented by one or more devices (e.g., one or more computing devices) or systems including, for example, the vehicle 104, the vehicle computing system 108, or the operations computing system 150, shown in FIG. 1. FIG. 4 includes an illustration of a remote computing device 400 that can be used exchange (e.g., send and/or receive) one or more signals or data with one or more computing systems including, for example, the vehicle 104, the vehicle computing system 108, or the operations computing system 150, shown in FIG. 1. As shown, FIG. 4 illustrates the remote computing device 400, a display component 402, a speaker component 404, a communication component 406, a microphone 408, a feedback query element 410, a control element 412, a control element 414, a feedback query element 420, a control element 422, and a control element 424.

The remote computing device 400 is a computing device (e.g., a computing device with one or more processors and one or more memory devices) that includes a display component 402 that can be used to display information including the feedback query element 410 and the feedback query element 420. In this example, the display component 402 is a touch screen display that is configured to detect tactile interactions with the display component 402 (e.g., a passenger touching the display component 402). Further, the remote computing device 400 can generate audio output including information associated with the feedback query element 410 and the feedback query element 420 via the speaker component 404.

In this example, the feedback query element 410 includes a feedback query (“Are you enjoying your trip?”) that is directed to a passenger of a vehicle (e.g., the vehicle 108). The passenger can respond to the feedback query by touching the control element 412 (“Yes”) to indicate that the passenger is enjoying the trip or by touching the control element 414 (“No”) to indicate that the passenger is not enjoying the trip. In this way, a passenger can provide a direct personal assessment of their enjoyment of the trip.

Further, the remote computing device 400 can generate the feedback query element 420 includes a feedback query (“Would you like the vehicle to slow down?”) that is directed to a passenger of a vehicle (e.g., the vehicle 108). The passenger can respond to the feedback query by touching the control element 422 (“Yes”) to indicate that the passenger would like the vehicle to slow down or by touching the control element 424 (“No”) to indicate that the passenger would not like the vehicle to slow down. Accordingly, a passenger is able to directly indicate whether the velocity of the vehicle is comfortable or should be reduced.

In some embodiments, a passenger can vocalize their response to a feedback query. The passenger vocalization can be detected by the microphone 408 which can be transmit the passenger vocalization to the remote computing device 400 and/or a computing device associated with the remote computing device 400 (e.g., the vehicle computing system 112).

The remote computing device 400 can display different types of feedback queries which can be provided periodically (e.g., a feedback query every five minutes), at specific times (e.g., at the start of a trip and/or at the end of a trip), and/or in response to various events (e.g., changes in the vehicle's velocity, acceleration, and/or trajectory). One or more signals and/or data including the information associated with the feedback query 410 and/or the feedback query 420 can be exchanged (e.g., sent and/or received) with another computing device (e.g., the vehicle computing system 112) via the communication component 406.

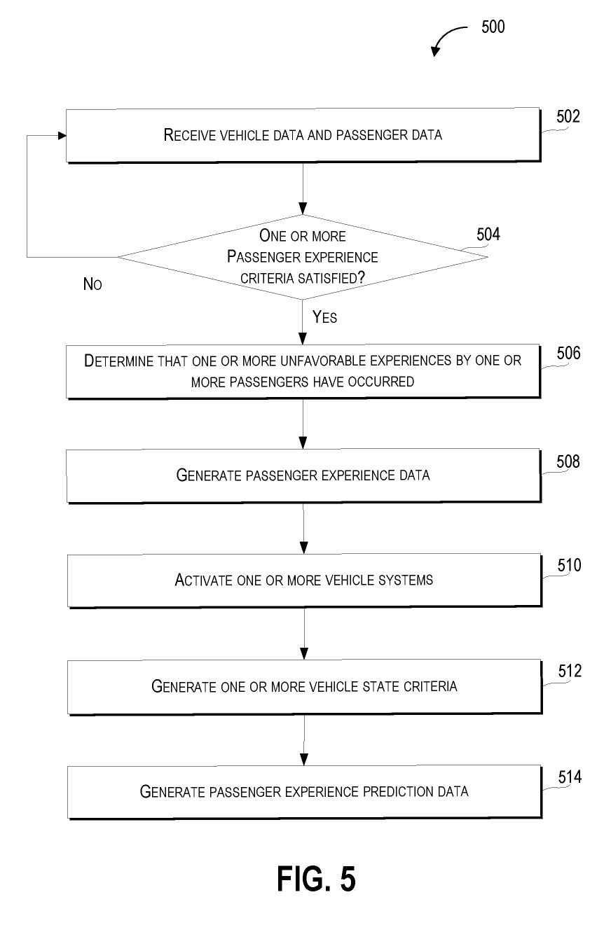

FIG. 5 depicts a flow diagram of an example method of determining a passenger experience according to example embodiments of the present disclosure. One or more portions of a method 500 can be implemented by one or more devices (e.g., one or more computing devices) or systems including, for example, the operations computing system 104, the vehicle 108, or the vehicle computing system 112, shown in FIG. 1. Moreover, one or more portions of the method 500 can be implemented as an algorithm on the hardware components of the devices described herein (e.g., as in FIG. 1) to, for example, determine the state of a vehicle and one or more passengers of the vehicle including determining one or more biometric or physiological states of the one or more passengers of the vehicle. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 502, the method 500 can include receiving vehicle data and passenger data. The vehicle data can be based at least in part on one or more states of a vehicle (e.g., an autonomous vehicle, a semi-autonomous vehicle, or a manually driven vehicle) and the passenger data can be based at least in part on one or more sensor outputs associated with one or more states of one or more passengers of the autonomous vehicle. For example, the vehicle (e.g., the vehicle 108) and or a computing device associated with the vehicle (e.g., the vehicle computing system 112) can include one or more transmitters and/or receivers that can send and/or receive one or more signals (e.g., one or more signals that are transmitted and/or received wirelessly and/or via wire) including the vehicle data and/or the passenger data.

The vehicle data can be based at least in part on one or more states of a vehicle (e.g., physical states based on the vehicle's motion and/or states of the vehicle's associated vehicle systems) and the passenger data can be based at least in part on one or more sensor outputs associated with one or more states of one or more passengers (e.g., one or more physiological states or biometric states) including passengers inside the vehicle.

In some embodiments, the vehicle data can be based at least in part on one or more states of the vehicle including a velocity of the vehicle; an acceleration of the vehicle; a deceleration of the vehicle (e.g., deceleration of the vehicle when the vehicle brakes); a turn direction of the vehicle (e.g., the vehicle turning left or right and the amount that the vehicle is turned left or right); a direction of travel of the vehicle (e.g., whether the vehicle is traveling forward or reversing); a lateral force on a passenger compartment of the vehicle (e.g., lateral force on the passenger compartment when the vehicle turns); a current geographic location of the vehicle (e.g., a latitude and longitude of the vehicle; an incline angle of the vehicle relative to the ground; a passenger compartment temperature of the vehicle (e.g., a temperature of the passenger compartment/cabin); a vehicle doorway state (e.g., whether a door is open, closed, and/or locked); and/or a vehicle window state (e.g., whether a window is open or closed and/or the amount that a window is open).

The one or more sensor outputs associated with the one or more states of the one or more passengers can be generated by one or more sensors including one or more biometric sensors or physiological sensors (e.g., one or more heart rate sensors, one or more electrocardiograms, one or more blood-pressure monitors, galvanic skin response devices, and/or voice tone detection devices), one or more image sensors (e.g., one or more cameras including visual spectrum cameras and/or infrared cameras), one or more thermal sensors, one or more tactile sensors (e.g., resistive touch sensors and/or pressure sensors), one or more capacitive sensors, and/or one or more audio sensors (e.g., one or more microphones).

Further, the one or more states of the one or more passengers can include heart rate (e.g., heart beats per minute), blood pressure (e.g., systolic and diastolic pressure), grip strength, blink rate (e.g., blinks per minute), facial expression (e.g., a facial expression determined by a facial recognition system), pupillary response, skin temperature, galvanic skin response, gestures (e.g., head, torso, hand, arm, foot, and/or leg gestures), amplitude of vocalization (e.g., loudness of vocalizations/speech by one or more passengers), frequency of vocalization (e.g., a number of vocalizations/speech per minute), and/or tone of vocalization (e.g., tone of vocalization/speech determined by a tone recognition system).

At 504, the method 500 can include determining whether, when, or that, the passenger data satisfies one or more passenger experience criteria. The one or more passenger experience criteria can specify one or more states including one or more unfavorable states associated with the one or more passengers. The one or more passenger experience criteria can specify or be associated with one or more unfavorable states (e.g., biometric states or physiological states of the one or more passengers that are associated with unpleasant and/or uncomfortable experiences for the one or more passengers) associated with the one or more passengers. For example, the one or more passenger experience criteria can specify one or more unfavorable states of the one or more passengers that are associated with physical responses (e.g., physical responses detected by a biometric device), vocalizations, gestures, facial expressions, and/or movements that correspond to reports by the one or more passengers of negative stress and/or discomfort.

Satisfying the one or more passenger experience criteria can include a comparison (e.g., a comparison by the vehicle computing system 112) of the passenger data (e.g., data including one or more attributes, parameters, and/or values) to passenger experience criteria data associated with the one or more passenger experience criteria including one or more corresponding attributes, parameters, and/or values. In some embodiments, the one or more passenger experience criteria can be based at least in part on one or more threshold ranges associated with the one or more states of the one or more passengers.

For example, the amplitude (e.g., loudness) of vocalization of a passenger measured in decibels by one or more sound sensors in the vehicle can be used to determine whether an amplitude of vocalization threshold has been exceeded. As such, an amplitude of vocalization of eighty decibels (80 dB) can be used as one of the one or more passenger experience criteria (e.g., an amplitude of vocalization that exceeds eighty decibels can satisfy at least one of the one or more passenger experience criteria). For example, the passenger data can include data associated with the amplitude of vocalization of a passenger of the vehicle. The data associated with the amplitude of vocalization associated with the passenger can be compared to one or more passenger criteria including an amplitude of vocalization threshold. Accordingly, satisfying the one or more passenger experience criteria can include the amplitude of vocalization exceeding or falling below an amplitude of vocalization threshold.

In response to the one or more passenger experience criteria being satisfied, the method 500 can proceed to 506. In response to the one or more passenger experience criteria not being satisfied, the method 500 can end or return to 502.

At 506, the method 500 can include determining, responsive to the one or more passenger experience criteria being satisfied, that one or more unfavorable experiences by the one or more passengers have occurred. For example, the vehicle computing system 112 can determine that one or more unfavorable experiences by the one or more passengers have occurred, which can cause the vehicle computing system 112 to activate one or more systems (e.g., computing systems associated with generating data) to initiate the generation of passenger experience data.

In response to the one or more unfavorable experiences by the one or more passengers being determined to have occurred, the method 500 can proceed to 508.

At 508, the method 500 can include generating passenger experience data that can be based at least in part on the vehicle data and/or the passenger data. For example, the vehicle computing system 112 can generate the passenger experience data which can be exchanged with one or more remote computing devices and/or stored locally on one or more storage devices of the vehicle computing system 112. The passenger experience data can include the vehicle data and/or the passenger data received at one or more time intervals (e.g., equal or unequal time intervals) associated with the one or more unfavorable experiences by the one or more passengers. The passenger experience data can include vehicle data and passenger data for a period of time including the one or more time intervals (e.g., the passenger experience data can include passenger data and/or vehicle data for one or more periods of time before and/or after the time of the one or more unfavorable experiences by the one or more passengers) and can include indicators that identify the one or more time intervals at which the vehicle computing system determined that one or more unfavorable experiences by the one or more passengers occurred.

For example, the vehicle data and the passenger data can be associated with a twenty minute time period (e.g., the duration of a time period associated with a trip by the vehicle that begins when a passenger enters a vehicle up and ends when the passenger exits the vehicle) and can include identifying data that indicates that an unfavorable experience (e.g., an unfavorable experience associated with amplitude of vocalization and tone of vocalization) occurred when a sharp turn was performed by the vehicle at the twelve minute mark and that a second unfavorable experience (e.g., an unfavorable experience associated with a raised hands gesture) occurred when hard braking was performed by the vehicle at the eighteen minute mark. Additionally, in some embodiments, portions of the passenger experience data that are not associated with the one or more unfavorable experiences by the one or more passengers can be identified as neutral experiences or positive experiences for the one or more passengers. Further, in some embodiments, favorable passenger experiences can be determined based on the passenger data (e.g., facial expressions including one or more passengers smiling, vocalizations including laughter, and/or body positions including a relaxed posture).

At 510, the method 500 can include activating one or more vehicle systems associated with operation of the vehicle. In some embodiments, activating the one or more vehicle systems can be performed in response to the passenger data satisfying the one or more passenger experience criteria or within a predetermined time period of the one or more passenger experience being satisfied. For example, a vehicle computing system (e.g., the vehicle computing system 112) can, in response to determining that the passenger data satisfies the one or more passenger experience criteria, activate one or more vehicle systems including passenger compartment systems (e.g., increasing temperature in the passenger compartment when the one or more passengers are too cold); illumination systems (e.g., turning on headlights when the vehicle enters a dark tunnel and passenger visibility is too low); notification systems (e.g., generate a textual message on a remote computing device of a passenger, asking a passenger if the passenger is comfortable); braking systems (e.g., reducing the sharpness of applying brakes when the passenger reports discomfort after a braking event by the vehicle); propulsion systems (e.g., increasing output from an electric motor in order to increase vehicle velocity when a passenger is uncomfortable that the velocity of the vehicle is too slow); and/or steering systems (e.g., steering the vehicle away from objects sooner in order to reduce passenger discomfort).

At 512, the method 500 can include generating one or more vehicle state criteria. The one or more vehicle state criteria can be based at least in part on the vehicle data at the one or more time intervals associated with the one or more unfavorable experiences by the one or more passengers. The one or more vehicle state criteria can include one or more states of the vehicle (e.g., velocity of the vehicle, acceleration of the vehicle, change in trajectory of the vehicle, and/or geographic location of the vehicle) that can correspond to the one or more unfavorable experiences of the one or more passengers. For example a vehicle computing system (e.g., the vehicle computing system 112) can generate an acceleration threshold based on the amount of acceleration by a vehicle when an unfavorable passenger experience is determined to have occurred.

At 514, the method 500 can include generating unfavorable experience prediction data. In some embodiments, generating the unfavorable experience prediction data can be based at least in part on a comparison of the vehicle data to the one or more vehicle state criteria. The unfavorable experience prediction data can include one or more predictions of an unfavorable experience at one or more time intervals subsequent to the one or more time intervals associated with the one or more unfavorable experienced by the one or more passengers.

For example, one or more vehicle state criteria can include one or more acceleration criteria (e.g., acceleration of the vehicle exceeding an acceleration threshold) corresponding to one or more unfavorable experiences by a passenger of the vehicle at a previous time. Based on the occurrence of the one or more unfavorable experiences by the one or more passengers at a previous time when the one or more acceleration criteria were satisfied, a vehicle computing system (e.g., the vehicle computing system 112) can determine, based on the vehicle's estimated travel path, that the vehicle will satisfy the one or more acceleration criteria within five seconds and can generate one or more predictions that the one or more passengers of the vehicle will have an unfavorable experience in five seconds time.

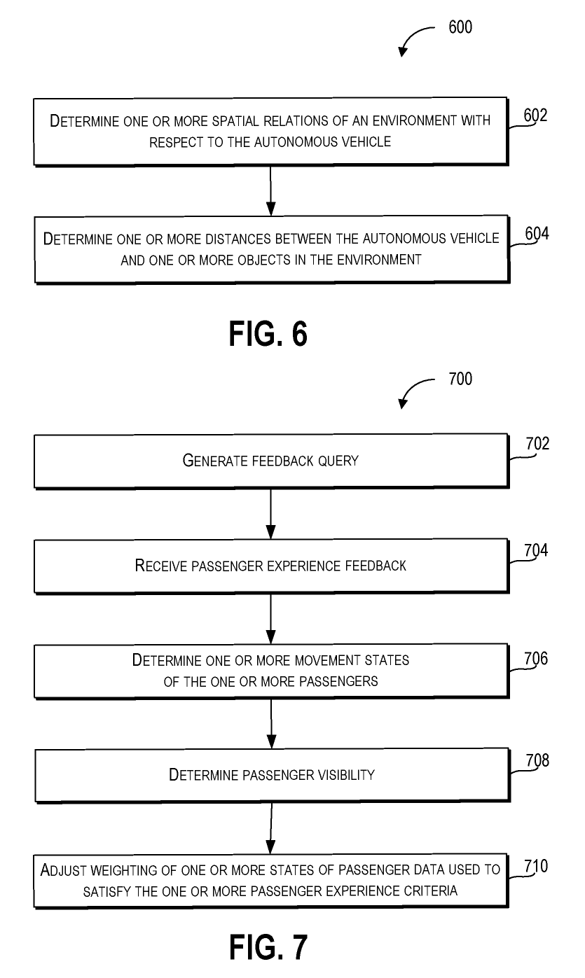

FIG. 6 depicts a flow diagram of an example method of determining a passenger experience according to example embodiments of the present disclosure. One or more portions of a method 600 can be implemented by one or more devices (e.g., one or more computing devices) or systems including, for example, the operations computing system 104, the vehicle 108, or the vehicle computing system 112, shown in FIG. 1. Moreover, one or more portions of the method 600 can be implemented as an algorithm on the hardware components of the devices described herein (e.g., as in FIG. 1) to, for example, determine the state of a vehicle and one or more passengers of the vehicle including determining one or more biometric or physiological states of the one or more passengers of the vehicle. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 602, the method 600 can include determining, based at least in part on one or more vehicle sensor outputs from one or more vehicle sensors of the vehicle (e.g., the vehicle 108), one or more spatial relations of an environment with respect to the vehicle. Further, the environment can include one or more objects external to the vehicle (e.g., buildings, other vehicles, and/or pedestrians). The one or more spatial relations can include a location (e.g., a geographic location and/or a location of the vehicle relative to one or more objects in the environment), proximity (e.g., distance between the vehicle and one or more objects in the environment), and/or position (e.g., a height, bearing, and/or orientation relative to a point of reference including the vehicle) of the one or more objects (e.g., other vehicles, buildings, cyclists, and/or pedestrians) external to the vehicle.

For example, the vehicle computing system 112 can determine the proximity of one or more vehicles within range of the vehicle's sensors. When the one or more unfavorable experiences by the one or more passengers are determined to have occurred, the location and/or position of the vehicle relative to the one or more objects in the environment recorded in the vehicle data can be analyzed as a factor in causing an unfavorable experience to the one or more passengers. In some embodiments, the vehicle data (e.g., the vehicle data in the method 500) can be based at least in part on the one or more vehicle sensor outputs.

At 604, the method 600 can include determining, based at least in part on the one or more spatial relations of the environment with respect to the vehicle, one or more distances between the vehicle and the one or more objects external to the vehicle. For example, the vehicle computing system 112 can determine that one or more unfavorable experiences by the one or more passengers occur when the vehicle is within one meter of another vehicle that has a height greater than four meters (e.g., an eighteen wheel truck). Further, when the other vehicle is within the proximity distance (i.e., one meter), the height of the other vehicle can be compared to the height threshold to determine whether the other vehicle exceeds the height threshold. In some embodiments, the one or more passenger experience criteria can be based at least in part on one or more distance thresholds corresponding to the one or more distances between the vehicle and the one or more objects.

FIG. 7 depicts a flow diagram of an example method of determining a passenger experience according to example embodiments of the present disclosure. One or more portions of a method 700 can be implemented by one or more devices (e.g., one or more computing devices) or systems including, for example, the operations computing system 104, the vehicle 108, or the vehicle computing system 112, shown in FIG. 1. Moreover, one or more portions of the method 700 can be implemented as an algorithm on the hardware components of the devices described herein (e.g., as in FIG. 1) to, for example, determine the state of a vehicle and one or more passengers of the vehicle including determining one or more biometric or physiological states of the one or more passengers of the vehicle. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 702, the method 700 can include generating a feedback query. The feedback query can include a request for passenger experience feedback from one or more passengers of a vehicle (e.g., the vehicle 108). Further, the feedback query can include one or more audio indications (e.g., an audio recording of a feedback query and/or a synthetically audio of a feedback query) and/or one or more visual indications (e.g., a feedback query generated on a display device in the vehicle and/or on a remote computing device of a passenger). For example, a computing system (e.g., the vehicle computing system 112) can generate a feedback query periodically (e.g., every ten minutes), when a predetermined event occurs (e.g., a passenger is dropped off), or when the vehicle data indicates that the vehicle is operating within an operational range (e.g., when the vehicle exceeds a predetermined velocity or rate of acceleration). In some embodiments, the gaze of a passenger can be used to determine where the feedback query will be generated (e.g., the feedback query is generated on a display device of the vehicle when the passenger's gaze is directed to the display device inside the vehicle).

At 704, the method 700 can include receiving passenger experience feedback from the one or more passengers. The passenger experience feedback can include vocal feedback (e.g., speech, laughter, coughing, and/or humming), performing a physical input (e.g., touching a touch interface, pressing or turning one or more controls, and/or typing a response to the feedback query), gestures (e.g., shrugging, nodding the head, shaking the head, thumbs up, and/or thumbs down), and/or facial expressions (e.g., grinning or frowning). For example, a passenger nodding in response to a feedback query requesting whether the passenger experience was positive can be determined to be an affirmative response. In some embodiments, the passenger data can include the passenger experience feedback.

At 706, the method 700 can include determining, based at least in part on the one or more sensor outputs, one or more movement states of the one or more passengers. The one or more movement states can include a velocity of movement (e.g., how quickly one or more passengers turn their bodies), frequency of movement (e.g., how often a passenger moves within a time interval), extent of movement (e.g., the range of motion of a passenger's movement), and/or type of movement (e.g., tapping one or both feet, tapping one or more fingers, raising one or more hands, tilting of the head, moving one or more legs, and/or leaning of the torso) of movement by the one or more passengers. For example, the vehicle computing system 112 can determine when a passenger suddenly turns their head, which upon comparison to the one or more passenger experience criteria can be determined to be a movement associated with an unfavorable experience by a passenger. In some embodiments, the passenger data can be based at least in part on the one or more movement states of the one or more passengers.

At 708, the method 700 can include determining, based at least in part on the vehicle data or the passenger data, passenger visibility. The passenger visibility can include the visibility to the one or more passengers of the environment external to vehicle including how much of the environment external to the vehicle that the one or more passengers can see (e.g., the unobstructed field of view of the one or more passengers) and/or the distance that the one or more passengers can see (e.g., the distance at which objects are perceptible, recognizable, or distinguishable).

The passenger visibility can be based in part on sensor outputs from one or more sensors that detect the one or more states of the vehicle (e.g., velocity, acceleration, trajectory, and/or location), the one or more states of the one or more passengers (e.g., one or more biometric or physiological states), and/or the one or more states of the environment external to the vehicle (e.g., the location and/or trajectory of one or more objects in the environment). For example, the one or more sensor outputs used to determine the passenger visibility can detect one or more states including the states of the one or more passengers pupils (e.g., less pupil dilation can correspond to more light and greater visibility); the states of the one or more passengers eyelids (e.g., the eyelid openness and/or shape of the one or more passengers can be used to determine whether a passenger's eyes are open or closed); an intensity and/or amount of light entering the passenger compartment of the vehicle (e.g., sunlight, moonlight, parking structure light, tunnel lights, lamplight, and/or headlight beams from other vehicles); an intensity and/or amount of light generated by the vehicle headlights and/or passenger compartment lights; an amount of precipitation external to the vehicle (e.g., rain, snow, sleet, and/or hail); an amount of suspension in the air external to the vehicle (e.g., fog, mist, and/or dust); and/or the unobstructed visibility distance (e.g., the distance a passenger can see before their vision is obstructed by an object including one or more buildings, foliage, hills, mountains, signage, other vehicles, natural features, cyclists, and/or pedestrians).

Further, in some embodiments, the passenger visibility can be based at least in part on one or more states of the environment external to the vehicle including weather conditions (e.g., rain, snow, fog, and/or hail); cloud cover (e.g., overcast or clear skies); time of day (e.g., dusk, dawn, midday, day-time, or night-time); traffic density (e.g., a number of vehicles, cyclists, and/or pedestrians within a predetermined distance of the vehicle); foliage density (e.g., the amount of foliage in an area including trees, plants, and/or bushes); building density (e.g., the amount of buildings within an area); an amount of window tinting on windows of the vehicle (e.g., tinted windows can reduce visibility in comparison to clear non-tinted windows) passenger seating location (e.g., a passenger in a rear seat may have less visibility than a passenger seated in a front seat); and/or the number of passengers in the vehicle (e.g., a passenger in a vehicle with many other passengers can have less visibility than a passenger in a vehicle with fewer or no other passengers).

At 710, the method 700 can include adjusting, based at least in part on the passenger visibility, a weighting of the one or more states of the passenger data used to satisfy the one or more passenger experience criteria. For example, a higher passenger visibility (e.g., the vehicle traveling on an open road during the day with clear and unobstructed visibility) can decrease the weighting of pupillary response and/or eyelid openness from the one or more passengers. Accordingly, passenger states including wide-open eyelids and/or constricted pupils can, under high visibility conditions, be less heavily weighted in the determination of whether one or more unfavorable experiences by the one or more passengers have occurred.

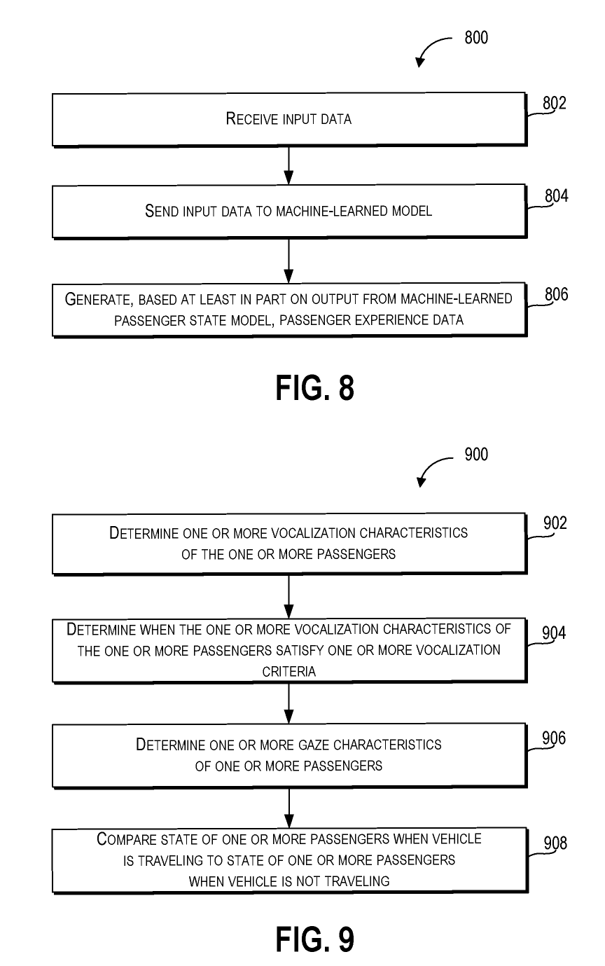

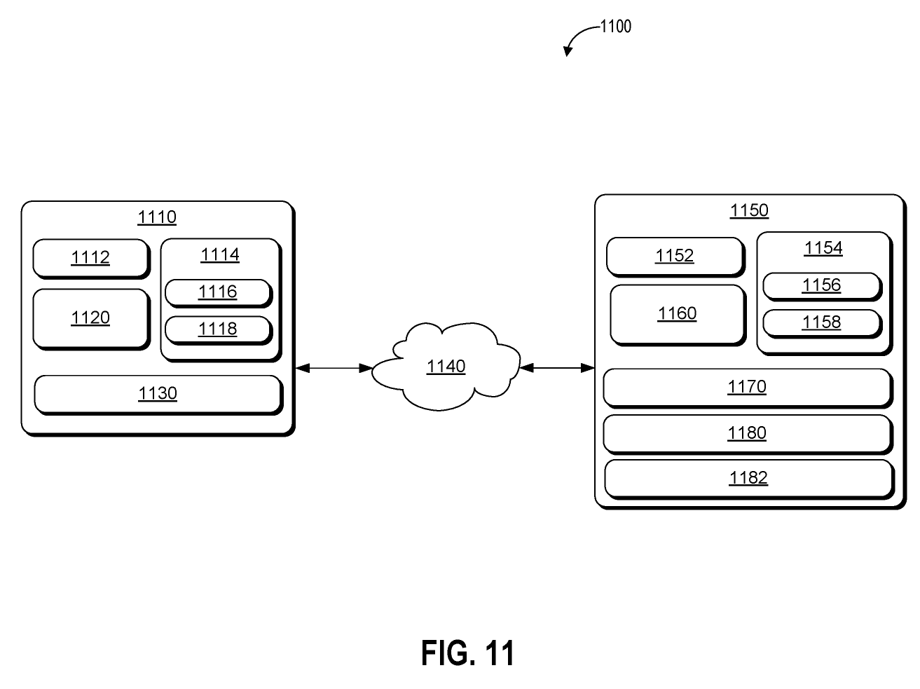

FIG. 8 depicts a flow diagram of an example method of determining a passenger experience according to example embodiments of the present disclosure. One or more portions of a method 800 can be implemented by one or more devices (e.g., one or more computing devices) or systems including, for example, the operations computing system 104, the vehicle 108, or the vehicle computing system 112, shown in FIG. 1; or the computing system 1100 shown in FIG. 11. Moreover, one or more portions of the method 800 can be implemented as an algorithm on the hardware components of the devices described herein (e.g., as in FIG. 1) to, for example, determine the state of a vehicle and one or more passengers of the vehicle including determining one or more biometric or physiological states of the one or more passengers of the vehicle. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 802, the method 800 can include receiving input data (e.g., the vehicle computing system 112, the computing system 1110, or the machine learning computing system 1150 can receive the input data). The input data can include the state data (e.g., the state data in the method 500) which can include vehicle data (e.g., data associated with one or more states of a vehicle) and/or passenger data (e.g., data associated with one or more states of one or more passengers of the vehicle). For example, the vehicle data can include data associated with the operation of a vehicle (e.g., the vehicle 108) including the velocity, acceleration, trajectory, and/or location of the vehicle and the passenger data can include data associated with one or more biometric or physiological states of one or more passengers of the vehicle (e.g., heart rate, blood pressure, pupillary response, respiratory rate).

At 804, the method 800 can include sending the input data to a machine-learned model. The machine-learned model can be trained to receive input data including the vehicle data and the passenger data and can, responsive to receiving the input data, generate an output comprising one or more unfavorable experience predictions. The machine-learned model can include the one or more machine-learned models 1130 and/or the one or more machine-learned models 1170.

For example, the machine-learned model can be implemented on a computing system (e.g., the vehicle computing system 112) associated with the vehicle (e.g., the vehicle 108) and can be configured to receive the input data via one or more communication networks (e.g., the communication network 102). For instance, the vehicle computing system 112 can include, employ, and/or otherwise leverage a machine-learned object detection and prediction model. The machine-learned object detection and prediction model can be or can otherwise include one or more various models including, for example, neural networks (e.g., deep neural networks), or other multi-layer non-linear models.

Neural networks can include convolutional neural networks, recurrent neural networks (e.g., long short-term memory recurrent neural networks), feed-forward neural networks, and/or other forms of neural networks. For instance, supervised training techniques can be performed to train the machine-learned object detection and prediction model to detect and/or predict an interaction between: one or more passengers of the vehicle and one or more objects (e.g., objects inside the vehicle); a first object (e.g., the vehicle 108) and one or more second objects (e.g., objects external to the vehicle 108); and/or the associated predicted interactions (e.g., using labeled driving log data, state data, and/or passenger experience data with known instances of interactions). In some implementations, training data for the machine-learned object detection and prediction model can be based at least in part on the predicted interaction outcomes determined using a rules-based model, that can be used to help train the machine-learned object detection and prediction model to detect and/or predict one or more interactions between the vehicle, the passengers, and/or one or more objects. Further, the training data can be used to train the machine-learned object detection and prediction model offline.

In some embodiments, the vehicle computing system 112 can input data into the machine-learned object detection and prediction model and receive an output. For instance, the vehicle computing system 112 can obtain data indicative of a machine-learned object detection and prediction model from an accessible memory onboard the vehicle 108 and/or from a memory that is remote from the vehicle 108 (e.g., via a wireless network). The vehicle computing system 112 can provide input data into the machine-learned object detection and prediction model. The input data can include the data associated with the state of the vehicle, the state of one or more passengers of the vehicle, and the state of one or more objects external to the vehicle including one or more vehicles, pedestrians, cyclists, buildings, and/or environments associated with the one or more objects (e.g., roads, bodies of water, hills, mountains, and/or forests). Further, the input data can include data indicative of the physiological or biometric state of one or more passengers of the vehicle (e.g., heart rate, blood pressure, and/or respiratory rate).

The machine-learned object detection and prediction model can process the input data to predict an interaction associated with an object (e.g., a passenger-vehicle interaction, an object-object interaction, and/or an object-vehicle interaction). Further, the vehicle computing system 112 can obtain an output from the machine-learned object detection and prediction model.

The output from the machine-learned object detection and prediction model can be indicative of the one or more predicted interactions (e.g., an unfavorable passenger experience by the one or more passengers). For example, the output can be indicative of the one or more predicted interactions within an environment. In some implementations, the vehicle computing system 112 can provide input data indicative of the predicted interaction and the machine-learned object detection and prediction model can output the predicted interactions based on such input data. In some implementations, the output can also be indicative of a probability associated with each respective interaction.

At 806, the method 800 can include generating, based at least in part on the output from the machine-learned model, passenger experience data including one or more unfavorable experience predictions associated with one or more unfavorable experiences by the one or more passengers. For example, the vehicle computing system 112 can generate, based at least in part on output from the machine-learned model, one or more detected passenger predictions that can be associated with passenger experience data including one or more detected visual states of the one or more passengers including one or more facial expressions (e.g., smiling, frowning, and/or closing eyes), one or more bodily gestures (e.g., turning the body, shrugging, raising one or more arms, tapping a foot, tapping one or more fingers, and/or turning a head), and/or one or more vocalizations (e.g., speaking, raising the voice, sighing, and/or whispering). Further, the passenger experience data can include one or more states of the vehicle (e.g., vehicle velocity, acceleration, trajectory, and/or location) including one or more states of the vehicle when one or more unfavorable passenger experiences are determined to have occurred.

FIG. 9 depicts a flow diagram of an example method of determining a passenger experience according to example embodiments of the present disclosure. One or more portions of a method 900 can be implemented by one or more devices (e.g., one or more computing devices) or systems including, for example, the operations computing system 104, the vehicle 108, or the vehicle computing system 112, shown in FIG. 1. Moreover, one or more portions of the method 900 can be implemented as an algorithm on the hardware components of the devices described herein (e.g., as in FIG. 1) to, for example, determine the state of a vehicle and one or more passengers of the vehicle including determining one or more biometric or physiological states of the one or more passengers of the vehicle. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 902, the method 900 can include determining, based at least in part on the passenger data (e.g., the passenger data in the method 500), one or more vocalization characteristics of the one or more passengers. For example, the passenger data can include sound data (e.g., data based in part on recordings from one or more microphones in the vehicle) associated with one or more sensor outputs from one or more microphones in a passenger compartment of the vehicle. A vehicle computing system (e.g., the vehicle computing system 112) can process the audio data to determine when the one or more passengers have produced one or more vocalizations and can further determine one or more vocalization characteristics of the one or more vocalizations including a timbre, pitch, frequency, amplitude, rate of vocalization, articulation, rhythm of vocalization, and/or duration.

At 904, the method 900 can include determining when the one or more vocalization characteristics satisfy one or more vocalization criteria associated with the one or more vocalization characteristics. For example, the method 900 can include determining (e.g., determining by the vehicle computing system 112) when the one or more vocalizations are associated with an unfavorable vocalization (e.g., a sudden intake of breath) of a plurality of unfavorable vocalizations that indicate the occurrence of an unfavorable experience. Further, the one or more vocalization criteria can be associated with the rate of unfavorable vocalization by the one or more passengers (e.g., the one or more vocalization criteria can be satisfied by the rate of unfavorable vocalization exceeding one unfavorable vocalization per fifteen minute time period). In some embodiments, satisfying the one or more passenger experience criteria can include the one or more vocalization characteristics satisfying the one or more vocalization criteria.

At 906, the method 900 can include determining, based at least in part on data including the vehicle data, the passenger data, and/or output from a machine-learned model (e.g., the machine-learned model in the method 800), one or more gaze characteristics of the one or more passengers.

The vehicle computing system 112 can include one or more sensors (e.g., one or more cameras) that can be used to track the movement of the one or more passengers (e.g., track the movement of the head, face, eyes, arms, legs, and/or torso of the one or more passengers) and generate one or more signals or data that can be processed by a gaze detection or gaze determination system of the vehicle computing system (e.g., a machine-learned model that has been trained to determine the direction and duration of a passenger's gaze).

In some embodiments, satisfying the one or more passenger experience criteria can include the one or more gaze characteristics satisfying one or more gaze characteristics including a direction and/or duration of one or more gazes by the one or more passengers. For example, the vehicle computing system 112 can determine that a passenger of the vehicle has been gazed through a front window of the vehicle a number of times that exceeds a gaze rate threshold associated with an unfavorable passenger experience. As such, repeated gazing through the rear window can be indicative of passenger discomfort (e.g., another vehicle to the rear of the vehicle carrying the passenger may be too close or traveling too rapidly).

At 908, the method 900 can include comparing the state of the one or more passengers when the vehicle (e.g., the autonomous vehicle) is traveling to the state of the one or more passengers when the vehicle is not traveling. The one or more states of the one or more passengers (e.g., one or more biometric or physiological states of the one or more passengers) can be detected and/or determined within a predetermined time period of the one or more passengers entering the vehicle and before the vehicle starts traveling. For example, a passenger's remote computing device (e.g., a wearable computing device including a heart rate monitor) can detect the heart rate of the passenger and transmit the heart rate to the vehicle computing system 112. The state of the passenger before the vehicle starts traveling can be used as a baseline value from which a threshold value can be determined. For example, the baseline heart rate of a passenger can be sixty-five (65) beats per minute after the passenger enters the vehicle and before the vehicle starts traveling. The vehicle computing system can then determine an individualized threshold heart rate that is based in part on a passenger's detected characteristics (e.g., age and/or gender) and/or a generic threshold heart rate that can be applicable to all passengers of the vehicle (e.g., a generic heart rate threshold of one hundred beats per minute). In this example, the one or more passenger criteria can be based at least in part on the difference between the baseline heart rate and the individualized threshold heart rate and/or the generic heart rate threshold. In some embodiments, the one or more passenger experience criteria can be based at least in part on one or more differences between the state of one or more passengers when the vehicle is traveling and the state of the one or more passengers when the vehicle is not traveling.

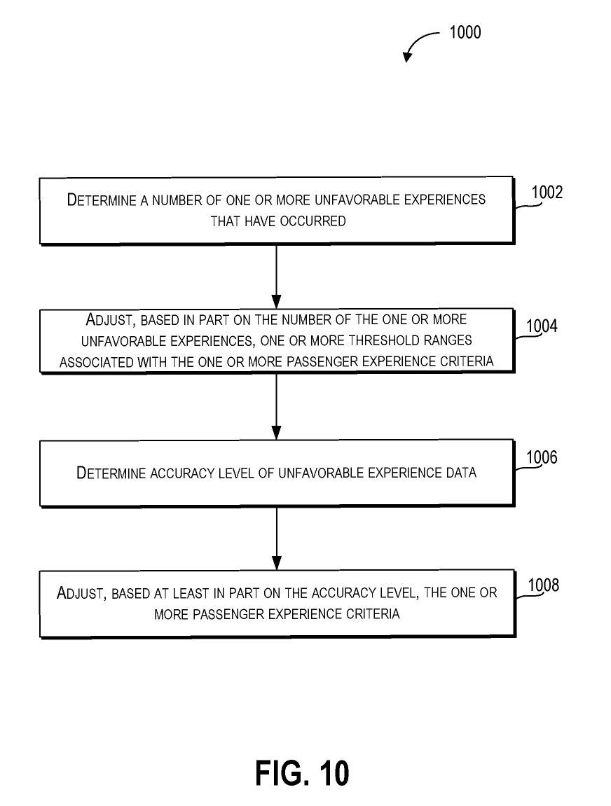

FIG. 10 depicts a flow diagram of an example method of determining a passenger experience according to example embodiments of the present disclosure. One or more portions of a method 1000 can be implemented by one or more devices (e.g., one or more computing devices) or systems including, for example, the operations computing system 104, the vehicle 108, or the vehicle computing system 112, shown in FIG. 1. Moreover, one or more portions of the method 1000 can be implemented as an algorithm on the hardware components of the devices described herein (e.g., as in FIG. 1) to, for example, determine the state of a vehicle and one or more passengers of the vehicle including determining one or more biometric or physiological states of the one or more passengers of the vehicle. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 1002, the method 1000 can include determining, based in part on the passenger experience data (e.g., the passenger experience data in the method 500), a number of the one or more unfavorable experiences by the one or more passengers that have occurred. For example, the passenger experience data can include an unfavorable experience data structure associated with the number of the one or more unfavorable experiences by the one or more passengers that have occurred. When an unfavorable experience is determined to have occurred, a value in the unfavorable experience data structure can be incremented (e.g., increased by one each time an unfavorable experience is determined to have occurred).

Further, the passenger experience data can include a number of different types of the one or more unfavorable experiences that have occurred based on the portion of the passenger data that satisfied the one or more passenger experience criteria. For example, the number of unfavorable passenger feedback responses to a feedback query (e.g., the feedback query in the method 700) can be counted as the number of unfavorable feedback query experiences, the number of unfavorable body movements (e.g., quickly grasping at a door handle) can be counted as the number of unfavorable movement responses, and the total number of unfavorable experiences can include the number of unfavorable feedback query responses and the number of unfavorable movement responses.

At 1004, the method 1000 can include adjusting, based at least in part on the number of the one or more unfavorable experiences by the one or more passengers that have occurred, one or more threshold ranges associated with the one or more passenger experience criteria. For example, a movement threshold for one or more movement states of the one or more passengers can be reduced when the number of unfavorable experiences by the one or more passengers exceeds one unfavorable experience in a ten minute period. As such, the passenger experience criterion for an unfavorable experience can be more easily satisfied as the number of unfavorable experiences increases.

Further, an unfavorable experience rate can be determined (e.g., determined by the vehicle computing system 112) based in part on the number of the one or more unfavorable experiences in a given time period (e.g., a number of unfavorable experiences per hour). The unfavorable experience rate can also be used to adjust the one or more threshold ranges associated with the one or more passenger experience criteria (e.g., a lower unfavorable experience rate can result in setting the one or more passenger experience criteria to a default value and a higher unfavorable experience rate can result in changing the one or more passenger experience criteria so that the one or more passenger experience criteria are more easily satisfied).

At 1006, the method 1000 can include determining, an accuracy level of the passenger experience data based at least in part on a comparison of the unfavorable experience data to ground-truth data associated with one or more previously recorded unfavorable passenger experiences or one or more previously recorded vehicle states. For example, the ground-truth data can include one or more previously reported (e.g., previously reported by one or more passengers of a vehicle) unfavorable experiences to which the passenger experience data can be compared in order to determine one or more differences in the one or more states of the passengers to one or more previously reported states of passengers reported in the ground-truth data. Further, one or more portions of the one or more previously reported unfavorable experiences can be aggregated to determine average, mean, mode, and median values associated with the one or more previously reported unfavorable experiences. For example, the number of unfavorable experiences in the passenger experience data can be compared to an average number of unfavorable experiences in the ground-truth data.

At 1008, the method 1000 can include adjusting, based at least in part on the accuracy level, the one or more passenger experience criteria. Further, the adjustment in the one or more passenger experience criteria can be based at least in part on one or more differences between the Further, the vehicle computing system 112 can adjust one or more threshold values of the one or more passenger experience criteria by moving a threshold value upwards or downwards based on the accuracy level with respect to the ground-truth data. For example, when the accuracy level is low, the one or more threshold values associated with the one or more passenger experience criteria can be adjusted by a greater amount than when the accuracy level is high. Further, when the accuracy level is high (e.g., the accuracy level exceeds an accuracy level threshold) the adjustment to the one or more passenger experience criteria can be a small amount.

FIG. 11 depicts a block diagram of an example computing system 1100 according to example embodiments of the present disclosure. The example computing system 1100 includes a computing system 1110 and a machine learning computing system 1150 that are communicatively coupled over a network 1140.

In some implementations, the computing system 1110 can perform various operations including the determination of one or more states of a vehicle (e.g., the vehicle 108) including the vehicle's location, position, orientation, velocity, and/or acceleration; the determination of one or more states of one or more objects inside the vehicle (e.g., one or more passengers of the vehicle); and/or the determination of the state of the environment proximate to the vehicle including the state of one or more objects proximate to the vehicle (e.g., the object's physical dimensions, location, position, orientation, velocity, acceleration, shape, and/or color). In some implementations, the computing system 1110 can be included in an autonomous vehicle. For example, the computing system 1110 can be on-board the autonomous vehicle. In other implementations, the computing system 1110 is not located on-board the autonomous vehicle. For example, the computing system 1110 can operate offline to determine one or more states of a vehicle (e.g., the vehicle 108) including the vehicle's location, position, orientation, velocity, and/or acceleration; determine one or more states of one or more objects inside the vehicle (e.g., one or more passengers inside the vehicle); and/or determine the state of the environment proximate to the vehicle including the state of one or more objects proximate to the vehicle (e.g., the object's physical dimensions, location, position, orientation, velocity, acceleration, shape, and/or color). Further, the computing system 1110 can include one or more distinct physical computing devices.

The computing system 1110 includes one or more processors 1112 and a memory 1114. The one or more processors 1112 can be any suitable processing device (e.g., a processor core, a microprocessor, an ASIC, a FPGA, a controller, and/or a microcontroller) and can be one processor or a plurality of processors that are operatively connected. The memory 1114 can include one or more non-transitory computer-readable storage media, including RAM, ROM, EEPROM, EPROM, one or more memory devices, flash memory devices, and/or combinations thereof.

The memory 1114 can store information that can be accessed by the one or more processors 1112. For instance, the memory 1114 (e.g., one or more non-transitory computer-readable storage mediums, memory devices) can store data 1116 that can be obtained, received, accessed, written, manipulated, created, and/or stored. The data 1116 can include, for instance, data associated with the determination of the state of a vehicle and one or more passengers of the vehicle as described herein. In some implementations, the computing system 1110 can obtain data from one or more memory devices that are remote from the system 1110.

The memory 1114 can also store computer-readable instructions 1118 that can be executed by the one or more processors 1112. The instructions 1118 can be software written in any suitable programming language or can be implemented in hardware. Additionally, or alternatively, the instructions 1118 can be executed in logically and/or virtually separate threads on the one or more processors 1112.

For example, the memory 1114 can store instructions 1118 that when executed by the one or more processors 1112 cause the one or more processors 1112 to perform any of the operations and/or functions described herein, including, for example, determining the state of a vehicle (e.g., the vehicle 108) and/or determining a state of passenger of the vehicle including the passenger's biometric or physiological states (e.g., heart rate, blood pressure, and/or respiratory rate).

According to an aspect of the present disclosure, the computing system 1110 can store or include one or more machine-learned models 1130. As examples, the machine-learned models 1130 can be or can otherwise include various machine-learned models including, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

In some implementations, the computing system 1110 can receive the one or more machine-learned models 1130 from the machine learning computing system 1150 over the network 1140 and can store the one or more machine-learned models 1130 in the memory 1114. The computing system 1110 can then use or otherwise implement the one or more machine-learned models 1130 (e.g., by the one or more processors 1112). In particular, the computing system 1110 can implement the one or more machine-learned models 1130 to determine a state of a vehicle (e.g., the vehicle 108) and/or determine a state of an object inside the vehicle (e.g., a passenger of the vehicle) including the object's biometric or physiological state.

The machine learning computing system 1150 includes one or more processors 1152 and a memory 1154. The one or more processors 1152 can be any suitable processing device (e.g., a processor core, a microprocessor, an ASIC, a FPGA, a controller, and/or a microcontroller) and can be one processor or a plurality of processors that are operatively connected. The memory 1154 can include one or more non-transitory computer-readable storage media, including RAM, ROM, EEPROM, EPROM, one or more memory devices, flash memory devices, and/or combinations thereof.

The memory 1154 can store information that can be accessed by the one or more processors 1152. For instance, the memory 1154 (e.g., one or more non-transitory computer-readable storage mediums, memory devices) can store data 1156 that can be obtained, received, accessed, written, manipulated, created, and/or stored. The data 1156 can include, for instance, determining a state of a vehicle (e.g., the vehicle 108) and/or determining a state of an object inside the vehicle (e.g., a passenger of the vehicle) including the object's biometric or physiological state as described herein. In some implementations, the machine learning computing system 1150 can obtain data from one or more memory devices that are remote from the system 1150.

The memory 1154 can also store computer-readable instructions 1158 that can be executed by the one or more processors 1152. The instructions 1158 can be software written in any suitable programming language or can be implemented in hardware. Additionally, or alternatively, the instructions 1158 can be executed in logically and/or virtually separate threads on the one or more processors 1152.

For example, the memory 1154 can store instructions 1158 that when executed by the one or more processors 1152 cause the one or more processors 1152 to perform any of the operations and/or functions described herein, including, for example, determining a state of a vehicle (e.g., the vehicle 108) and/or determining a state of an object inside the vehicle (e.g., a passenger of the vehicle) including the object's biometric or physiological state.

In some implementations, the machine learning computing system 1150 includes one or more server computing devices. If the machine learning computing system 1150 includes multiple server computing devices, such server computing devices can operate according to various computing architectures, including, for example, sequential computing architectures, parallel computing architectures, or some combination thereof.

In addition or alternatively to the one or more machine-learned models 1130 at the computing system 1110, the machine learning computing system 1150 can include one or more machine-learned models 1170. As examples, the one or more machine-learned models 1170 can be or can otherwise include various machine-learned models including, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

As an example, the machine learning computing system 1150 can communicate with the computing system 1110 according to a client-server relationship. For example, the machine learning computing system 1150 can implement the one or more machine-learned models 1170 to provide a web service to the computing system 1110. For example, the web service can provide determining a state of a vehicle (e.g., the vehicle 108) and/or determining a state of an object inside the vehicle (e.g., a passenger of the vehicle) including the object's biometric or physiological state.

Thus the one or more machine-learned models 1130 can located and used at the computing system 1110 and/or the one or more machine-learned models 1170 can be located and used at the machine learning computing system 1150.

In some implementations, the machine learning computing system 1150 and/or the computing system 1110 can train the machine-learned models 1130 and/or 1170 through use of a model trainer 1180. The model trainer 1180 can train the machine-learned models 1130 and/or 1170 using one or more training or learning algorithms. One example training technique is backwards propagation of errors. In some implementations, the model trainer 1180 can perform supervised training techniques using a set of labeled training data. In other implementations, the model trainer 1180 can perform unsupervised training techniques using a set of unlabeled training data. The model trainer 1180 can perform a number of generalization techniques to improve the generalization capability of the models being trained. Generalization techniques include weight decays, dropouts, or other techniques.

In particular, the model trainer 1180 can train the one or more machine-learned models 1130 and/or the one or more machine-learned models 1170 based on a set of training data 1182. The training data 1182 can include, for example, a plurality of objects including vehicle objects, passenger objects, cyclist objects, building objects, and/or road objects, which can be associated with various characteristics and/or properties (e.g., passengers with different ages, sizes, somatotypes, and/or health conditions). The model trainer 1180 can be implemented in hardware, firmware, and/or software controlling one or more processors.

The computing system 1110 can also include a network interface 1120 used to communicate with one or more systems or devices, including systems or devices that are remotely located from the computing system 1110. The network interface 1120 can include any circuits, components, and/or software, for communicating with one or more networks (e.g., the network 1140). In some implementations, the network interface 1120 can include, for example, one or more of a communications controller, receiver, transceiver, transmitter, port, conductors, software and/or hardware for communicating data. Similarly, the machine learning computing system 1150 can include a network interface 1160.

The networks 1140 can be any type of network or combination of networks that allows for communication between devices. In some embodiments, the network 1140 can include one or more of a local area network, wide area network, the Internet, secure network, cellular network, mesh network, peer-to-peer communication link and/or some combination thereof and can include any number of wired or wireless links. Communication over the network 1140 can be accomplished, for instance, via a network interface using any type of protocol, protection scheme, encoding, format, and/or packaging.

FIG. 11 illustrates one example computing system 1100 that can be used to implement the present disclosure. Other computing systems can be used as well. For example, in some implementations, the computing system 1110 can include the model trainer 1180 and the training dataset 1182. In such implementations, the machine-learned models 1130 can be both trained and used locally at the computing system 1110. As another example, in some implementations, the computing system 1110 is not connected to other computing systems.

In addition, components illustrated and/or discussed as being included in one of the computing systems 1110 or 1150 can instead be included in another of the computing systems 1110 or 1150. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of autonomous vehicle operation, the computer-implemented method comprising:
receiving, by a computing system comprising one or more computing devices, vehicle data and passenger data, wherein the vehicle data is based at least in part on one or more states of an autonomous vehicle and the passenger data is based at least in part on one or more sensor outputs associated with one or more states of one or more passengers of the autonomous vehicle;
responsive to the passenger data satisfying one or more passenger experience criteria, determining, by the computing system, that one or more unfavorable experiences by the one or more passengers have occurred, wherein the one or more passenger experience criteria specify one or more unfavorable states associated with the one or more passengers; and
generating, by the computing system, passenger experience data based at least in part on the vehicle data and the passenger data at one or more time intervals associated with the one or more unfavorable experiences by the one or more passengers.

2. The computer-implemented method of claim 1, wherein the vehicle data is based at least in part on the one or more states of the autonomous vehicle comprising velocity of the autonomous vehicle, acceleration of the autonomous vehicle, deceleration of the autonomous vehicle, turn direction of the autonomous vehicle, incline angle of the autonomous vehicle with respect to a ground surface, lateral force on a passenger compartment of the autonomous vehicle, passenger compartment temperature of the autonomous vehicle, autonomous vehicle doorway state, or autonomous vehicle window state.

3. The computer-implemented method of claim 1, further comprising:
generating, by the computing system, one or more vehicle state criteria based at least in part on the vehicle data at the one or more time intervals associated with the one or more unfavorable experiences by the one or more passengers; and
generating, by the computing system, based in part on a comparison of the vehicle data to the one or more vehicle state criteria, unfavorable experience prediction data comprising one or more predictions of an unfavorable experience at one or more time intervals subsequent to the one or more time intervals associated with the one or more unfavorable experienced by the one or more passengers.

4. The computer-implemented method of claim 1, further comprising:
determining, by the computing system, based at least in part on one or more vehicle sensor outputs from one or more vehicle sensors of the autonomous vehicle, one or more spatial relations of an environment with respect to the autonomous vehicle, the environment comprising one or more objects external to the vehicle, wherein the vehicle data is based in part on the one or more vehicle sensor outputs.

5. The computer-implemented method of claim 4, further comprising:
determining, by the computing system, based at least in part on the one or more spatial relations of the environment with respect to the autonomous vehicle, one or more distances between the autonomous vehicle and the one or more objects external to the autonomous vehicle, wherein the one or more passenger experience criteria are based at least in part on one or more distance thresholds corresponding to the one or more distances between the autonomous vehicle and the one or more objects.

6. The computer-implemented method of claim 1, further comprising:
responsive to the passenger data satisfying the one or more passenger experience criteria, activating, by the computing system, one or more vehicle systems associated with operation of the autonomous vehicle.

7. The computer-implemented method of claim 1, wherein the one or more sensor outputs associated with the passenger data are generated by one or more sensors comprising one or more biometric sensors, one or more image sensors, one or more thermal sensors, one or more tactile sensors, one or more capacitive sensors, or one or more audio sensors.

8. The computer-implemented method of claim 1, wherein the passenger data is based at least in part on the one or more states of the of the one or more passengers comprising heart rate, blood pressure, grip strength, blink rate, facial expression, pupillary response, skin temperature, amplitude of vocalization, frequency of vocalization, or tone of vocalization.

9. The computer-implemented method of claim 8, wherein the one or more passenger experience criteria are based at least in part on one or more threshold ranges associated with the one or more states of the one or more passengers.

10. The computer-implemented method of claim 1, further comprising:
generating, by the computing system, a feedback query requesting passenger experience feedback from the one or more passengers, the feedback query comprising one or more audio indications or one or more visual indications; and
receiving, by the computing system, passenger experience feedback from the one or more passengers, wherein the passenger data comprises the passenger experience feedback.

11. The computer-implemented method of claim 1, further comprising:
determining, by the computing system, based at least in part on the one or more sensor outputs, one or more movement states of the one or more passengers, the one or more movement states comprising velocity, frequency, extent, or type of movement by the one or more passengers, wherein the passenger data is based at least in part on the one or more movement states of the one or more passengers.

12. The computer-implemented method of claim 1, further comprising:
determining, by the computing system, based at least in part on the passenger data, one or more vocalization characteristics of the one or more passengers; and
determining, by the computing system, when the one or more vocalization characteristics satisfy one or more vocalization criteria associated with the one or more vocalization characteristics, wherein the satisfying the one or more passenger experience criteria comprises the one or more vocalization characteristics satisfying the one or more vocalization criteria.

13. The computer-implemented method of claim 1, further comprising:
determining, by the computing system, based at least in part on the vehicle data or the passenger data, passenger visibility comprising visibility to the one or more passengers of the environment external to autonomous vehicle; and
adjusting, by the computing system, based at least in part on the passenger visibility, a weighting of the one or more states of the passenger data used to satisfy the one or more passenger experience criteria.

14. The computer-implemented method of claim 13, wherein the visibility is based at least in part on one or more states of the environment external to the autonomous vehicle comprising weather condition, time of day, traffic density, foliage density, or building density.

15. A computing system, comprising:
one or more processors;
a machine-learned model trained to receive input data comprising vehicle data and passenger data and, responsive to receiving the input data, generate an output comprising one or more unfavorable experience predictions;
a memory comprising one or more computer-readable media, the memory storing computer-readable instructions that when executed by the one or more processors cause the one or more processors to perform operations comprising:
receiving input data comprising vehicle data and passenger data, wherein the vehicle data is based at least in part on one or more states of an autonomous vehicle and the passenger data is based at least in part on one or more sensor outputs associated with one or more states of one or more passengers of the autonomous vehicle;
sending the input data to the machine-learned model; and
generating, based at least in part on the output from the machine-learned model, passenger experience data comprising one or more unfavorable experience predictions associated with one or more unfavorable experiences by the one or more passengers.

16. The computing system of claim 15, further comprising:
determining, based at least in part on the output from the machine-learned model, one or more gaze characteristics of the one or more passengers, wherein the satisfying the one or more passenger experience criteria comprises the one or more gaze characteristics satisfying one or more gaze characteristics comprising a direction or duration of one or more gazes by the one or more passengers.

17. The computing system of claim 15, further comprising:
comparing the state of the one or more passengers when the autonomous vehicle is traveling to the state of the one or more passengers when the autonomous vehicle is not traveling, wherein the one or more passenger experience criteria are based at least in part on one or more differences between the state of one or more passengers when the vehicle is traveling and the state of the one or more passengers when the vehicle is not traveling.

18. An autonomous vehicle comprising:
one or more processors;
a memory comprising one or more computer-readable media, the memory storing computer-readable instructions that when executed by the one or more processors cause the one or more processors to perform operations comprising:
receiving vehicle data and passenger data, wherein the vehicle data is based at least in part on one or more states of an autonomous vehicle and the passenger data is based at least in part on one or more sensor outputs associated with one or more states of one or more passengers of the autonomous vehicle;
responsive to the passenger data satisfying one or more passenger experience criteria, determining that one or more unfavorable experiences by the one or more passengers have occurred, wherein the one or more passenger experience criteria specify one or more unfavorable states associated with the one or more passengers; and
generating passenger experience data based at least in part on the vehicle data and the passenger data at the one or more time intervals associated with the one or more unfavorable experiences by the one or more passengers.

19. The autonomous vehicle of claim 18, further comprising:
determining, based in part on the passenger experience data, a number of the one or more unfavorable experiences by the one or more passengers that have occurred; and
adjusting, based at least in part on the number of the one or more unfavorable experiences by the one or more passengers that have occurred, one or more threshold ranges associated with the one or more passenger experience criteria.

20. The autonomous vehicle of claim 18, further comprising:
determining an accuracy level of the passenger experience data based at least in part on a comparison of the unfavorable experience data to ground-truth data associated with one or more previously recorded unfavorable passenger experiences or one or more previously recorded vehicle states; and
adjusting, based at least in part on the accuracy level, the one or more passenger experience criteria.
